(19) United States
(12) Patent Application Publication
(10) Pub. No.: US 2025/0306487 A1
(43) Pub. Date: Oct. 2, 2025

(54) ELECTROSTATIC CHARGE IMAGE DEVELOPING TONER SET, ELECTROSTATIC CHARGE IMAGE DEVELOPER SET, TONER CARTRIDGE SET, PROCESS CARTRIDGE, IMAGE FORMING APPARATUS, AND IMAGE FORMING METHOD

(71) Applicant: FUJIFILM Business Innovation Corp., Tokyo (JP)

(72) Inventors: Erina SAITO, Kanagawa (JP); Tomohito NAKAJIMA, Kanagawa (JP); Daisuke ISHIZUKA, Kanagawa (JP); Tsutomu FURUTA, Kanagawa (JP); Narumasa SATO, Kanagawa (JP); Eiji KAWAKAMI, Kanagawa (JP); Mako TSUCHIYA, Kanagawa (JP)

(73) Assignee: FUJIFILM Business Innovation Corp., Tokyo (JP)

(21) Appl. No.: 19/083,467

(22) Filed: Mar. 19, 2025

(30) Foreign Application Priority Data
Mar. 27, 2024 (JP) 2024-052548
Jan. 21, 2025 (JP) 2025-008659

(51) Int. Cl. G03G 9/087; G03G 21/18

(52) U.S. Cl. CPC G03G 9/08733; G03G 21/1814

(57) ABSTRACT

An electrostatic charge image developing toner set contains a black toner having black toner particles that contain a binder resin and a black colorant; and a magenta toner having magenta toner particles that contain a binder resin and a magenta colorant, in which the binder resin contained in the black toner particles and the magenta toner particles includes an amorphous polyester resin and a crystalline polyester resin, a content of the crystalline polyester resin with respect to the binder resin in the black toner particles and the magenta toner particles is 7% by mass or more and 40% by mass or less, the amorphous polyester resin contained in the black toner particles and the magenta toner particles consists of a constitutional unit derived from a polyvalent carboxylic acid and a constitutional unit derived from a polyhydric alcohol, and a relationship between a mass proportion (% by mass) P(K) of the constitutional unit derived from a phthalic acid other than terephthalic acid with respect to the constitutional unit derived from a polyvalent carboxylic acid in the amorphous polyester resin contained in the black toner particles and a mass proportion (% by mass) P(M) of the constitutional unit derived from a phthalic acid other than terephthalic acid with respect to the constitutional unit derived from a polyvalent carboxylic acid in the amorphous polyester resin contained in the magenta toner particles satisfies the following expression (P1).

$$10 \leq P ( M ) - P ( K ) \leq 40 \qquad Expression ( P1 )$$

### CROSS-REFERENCE TO RELATED APPLICATIONS

This application is based on and claims priority under 35 USC 119 from Japanese Patent Application No. 2025-008659 filed Jan. 21, 2025 and Japanese Patent Application No. 2024-052548 filed Mar. 27, 2024.

### BACKGROUND

### (i) Technical Field

The present invention relates to an electrostatic charge image developing toner set, an electrostatic charge image developer set, a toner cartridge set, a process cartridge, an image forming apparatus, and an image forming method.

### (ii) Related Art

JP2013-257363 A discloses “toner containing at least a polyester resin, in which the polyester resin has a specific structural unit”.

JP2004-361520A discloses “full color toner consisting of a black toner and at least one color toner, each of which contains a binder resin and a colorant, in which an aromatic density of the binder resin contained in the black toner (black toner aromatic density) is lower than an aromatic density of the binder resin contained in each color toner (color toner aromatic density), a difference between the black toner aromatic density and the lowest color aromatic density is larger than any difference between the color toner aromatic densities, and a difference between the black toner aromatic density and any color toner aromatic density is 1% to 14% by mass”.

JP2004-361817A discloses “full color toner consisting of a black toner and at least one color toner, each of which contains a binder resin and a colorant, in which an unsaturation degree of the binder resin contained in the black toner (black toner unsaturation degree) is lower than an unsaturation degree of the binder resin contained in each color toner (color toner unsaturation degree), a difference between the black toner unsaturation degree and the lowest color toner unsaturation degree is larger than any difference between the color toner unsaturation degrees, and a difference between the black toner unsaturation degree and any color toner unsaturation degree is 0.1 to 1.5 mol/1000 g″.

JP2010⁻²³⁰⁹¹⁴A discloses “image forming method including an electrostatic image forming step of forming an electrostatic image on a surface of an image holder, a development step of developing the electrostatic image with a black toner for light fixing and a color toner for light fixing to form a black toner image and a color toner image, a transfer step of transferring the black toner image and the color toner image formed in the development step to a surface of a transfer object, and a light fixing step of fixing the black toner image and the color toner image transferred to the surface of the transfer object by exposure to light in an infrared range, in which the black toner is black toner that is melted by the exposure to light in the infrared range in the light fixing step, the color toner contains an infrared absorber, a light absorbance of the color toner at a peak wavelength of the light in the infrared range irradiated in the light fixing step is 79% or more and 98% or less with respect to a light absorbance of the black toner at the peak wavelength, and a color difference ΔE is 20 or less”.

JP2011-43662A discloses “electrostatic charge image developing toner set consisting of two or more kinds of toners having different hues, in which a difference between the maximum value and the minimum value of an absorbance a of each toner at 380 to 1,500 nm is 0.1 or less”.

### SUMMARY

Aspects of non-limiting embodiments of the present disclosure relate to an electrostatic charge image developing toner set, an electrostatic charge image developer set, a toner cartridge set, a process cartridge, an image forming apparatus, and an image forming method that provide an electrostatic charge image developing toner set containing a black toner having black toner particles that contain a binder resin and a black colorant and a magenta toner having magenta toner particles that contain a binder resin and a magenta colorant, in which the binder resin of the black toner particles and the magenta toner particles includes an amorphous polyester resin and a crystalline polyester resin and a content of the crystalline polyester resin with respect to the binder resin in the black toner particles and the magenta toner particles is 7% by mass or more and 40% by mass or less, where the electrostatic charge image developing toner set can suppress non-uniformity of glossiness of a black image and a magenta image generated in a case of being exposed to an outdoor environment while ensuring low-temperature fixability, as compared with a case where a relationship between a mass proportion (% by mass) P(K) of a constitutional unit derived from a phthalic acid other than terephthalic acid with respect to a constitutional unit derived from a polyvalent carboxylic acid in the amorphous polyester resin contained in the black toner particles and a mass proportion (% by mass) P(M) of a constitutional unit derived from a phthalic acid other than terephthalic acid with respect to a constitutional unit derived from a polyvalent carboxylic acid in the amorphous polyester resin contained in the magenta toner particles does not satisfy an expression (P1).

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

Methods for achieving the above object include the following aspect.

According to an aspect of the present disclosure, there is provided an electrostatic charge image developing toner set containing a black toner having black toner particles that contain a binder resin and a black colorant; and a magenta toner having magenta toner particles that contain a binder resin and a magenta colorant, in which the binder resin contained in the black toner particles and the magenta toner particles includes an amorphous polyester resin and a crystalline polyester resin, a content of the crystalline polyester resin with respect to the binder resin in the black toner particles and the magenta toner particles is 7% by mass or more and 40% by mass or less, the amorphous polyester resin contained in the black toner particles and the magenta toner particles consists of a constitutional unit derived from a polyvalent carboxylic acid and a constitutional unit derived from a polyhydric alcohol, and a relationship between a mass proportion (% by mass) P(K) of the constitutional unit derived from a phthalic acid other than terephthalic acid with respect to the constitutional unit derived from a polyvalent carboxylic acid in the amorphous polyester resin contained in the black toner particles and a mass proportion (% by mass) P(M) of the constitutional unit derived from a phthalic acid other than terephthalic acid with respect to the constitutional unit derived from a polyvalent carboxylic acid in the amorphous polyester resin contained in the magenta toner particles satisfies the following expression (P1),

$$10 \leq P ( M ) - P ( K ) \leq 40 \qquad expression ( P1 )$$

### BRIEF DESCRIPTION OF THE DRAWINGS

Exemplary embodiment(s) of the present invention will be described in detail based on the following figures, wherein:

FIG. 1 is a view schematically showing the configuration of an example of an image forming apparatus according to the present exemplary embodiment; and

FIG. 2 is a view schematically showing the configuration of an example of a process cartridge detachable from the image forming apparatus according to the present exemplary embodiment.

### DETAILED DESCRIPTION

Hereinafter, an exemplary embodiment that is one example of the present invention will be described. The following description and Examples merely show the exemplary embodiment and do not limit the scope of the invention.

An upper limit value or a lower limit value described in one numerical range described in a stepwise manner in the present specification may be replaced with an upper limit value or a lower limit value in another numerical range described in a stepwise manner. In addition, an upper limit value or a lower limit value in a numerical range described in the present specification may be replaced with a value described in examples.

In the present specification, (meth)acrylic means both acrylic and methacrylic.

In the present specification, the term “step” includes not only an independent step but a step that is not clearly distinguished from other steps as long as the intended purpose of the step is achieved.

Each of components may include plural kinds of corresponding materials.

In a case where the amount of each of components in a composition is described and plural kinds of materials corresponding to the component are present in the composition, unless specified otherwise, the amount of the component refers to the total amount of the plural kinds of materials present in the composition.

### Electrostatic Charge Image Developing Toner Set

The electrostatic charge image developing toner set (hereinafter, also referred to as “toner set”) according to the present exemplary embodiment contains black toner having black toner particles that a binder resin and a black colorant, and magenta toner having magenta toner particles that a binder resin and a magenta colorant.

The binder resin contained in the black toner particles and the magenta toner particles includes an amorphous polyester resin and a crystalline polyester resin.

A content of the crystalline polyester resin with respect to the binder resin in the black toner particles and the magenta toner particles is 7% by mass or more and 40% by mass or less.

The amorphous polyester resin contained in the black toner particles and the magenta toner particles includes a constitutional unit derived from a polyvalent carboxylic acid and a constitutional unit derived from a polyhydric alcohol.

A relationship between a mass proportion (% by mass) P(K) of the constitutional unit derived from a phthalic acid other than terephthalic acid with respect to the constitutional unit derived from a polyvalent carboxylic acid in the amorphous polyester resin contained in the black toner particles (that is, all amorphous polyester resins contained in the toner particles) and a mass proportion (% by mass) P(M) of the constitutional unit derived from a phthalic acid other than terephthalic acid with respect to the constitutional unit derived from a polyvalent carboxylic acid in the amorphous polyester resin contained in the magenta toner particles (that is, all amorphous polyester resins contained in the toner particles) satisfies an expression (P1) described later.

With the above-described configuration, the toner set according to the present exemplary embodiment can suppress non-uniformity of glossiness of a black image and a magenta image generated in a case of being exposed to an outdoor environment while ensuring low-temperature fixability. The reason for this configuration is presumed to be as follows.

In the related art, in order to achieve both low-temperature fixability and thermal storage stability, a toner obtained by using an amorphous polyester resin and a crystalline polyester resin in combination is known.

However, in the toner obtained by using an amorphous polyester resin and a crystalline polyester resin in combination, the crystalline polyester resin is likely to undergo molecular movement at a high temperature. For the reason, in a case where an image is exposed to an outdoor environment (that is, under direct sunlight), the outermost surface of the image may be softened by heat, and image glossiness may be slightly increased.

In a case of a monochromatic image, the entire image is in a state of being close to uniform at a high temperature, and the glossiness is increased in a state of being close to uniform, so that non-uniformity of the glossiness of the image is small, and it is difficult to feel discomfort in the image.

On the other hand, in a case of a multicolor image having a black image and a color image other than black, the black image is more likely to absorb light on an image surface and is more likely to have a higher temperature than the color image other than the black image. Therefore, a change in glossiness of the black image is larger than change in glossiness of the color image other than the black image. As a result, a high-gloss portion and a low-gloss portion may be generated in the same image, and the glossiness may be non-uniform.

In particular, under visible light, a magenta image has lower light absorption than other colors, and thus the difference in glossiness with the black image is large, and the non-uniformity of the glossiness is easily visually recognized.

On the other hand, the toner set according to the present exemplary embodiment has a configuration in which the relationship between the mass proportion (% by mass) P(K) of the constitutional unit derived from a phthalic acid other than terephthalic acid in the amorphous polyester resin contained in the black toner particles and the mass proportion (% by mass) P(M) of the constitutional unit derived from a phthalic acid other than terephthalic acid in the amorphous polyester resin contained in the magenta toner particles satisfies the expression (P1) described later.

That is, the mass proportion of the constitutional unit derived from a phthalic acid other than terephthalic acid in the amorphous polyester resin contained in the magenta toner particles is increased as compared with the mass proportion in the amorphous polyester resin contained in the black toner particles.

In a case where a main chain of the amorphous polyester resin has the constitutional unit derived from a phthalic acid other than terephthalic acid a portion that is bent is present in the main chain, and a void is easily formed between molecular chains.

In the toner particles containing the amorphous polyester resin and the crystalline polyester resin, in a case where there are voids in the amorphous polyester resin, a phenomenon in which the crystalline polyester resin enters the void portion of the amorphous polyester resin occurs due to heating and cooling during toner fixing.

In this case, the toner to which the amorphous polyester resin having a large number of constitutional units derived from a phthalic acid other than terephthalic acid is applied has a higher presence ratio of the crystalline polyester resin on a surface of an image to be formed.

That is, in a case of the configuration in which the mass proportion of the constitutional unit derived from a phthalic acid other than terephthalic acid in the amorphous polyester resin contained in the magenta toner particles is increased as compared with the mass proportion in the amorphous polyester resin contained in the black toner particles, the presence ratio of the crystalline polyester resin on the image surface is higher in the magenta image formed of the magenta toner than in the black image formed of the black toner.

Therefore, molecular movement of the crystalline polyester resin on the image surface at a high temperature is higher in the magenta image formed of the magenta toner than in the black image formed of the black toner. As a result, in a case where the image is exposed to an outdoor environment (that is, under direct sunlight) and the temperature of the image surface increases, the glossiness of the magenta image formed of the magenta toner increases to the same level as the glossiness of the black image formed of the black toner. In other words, a decrease in glossiness of the black image formed of the black toner is suppressed to the same level as a decrease in glossiness of the magenta image formed of the magenta toner.

As a result, a difference in glossiness between the black image and the magenta image is reduced, and the non-uniformity of glossiness between the black image and the magenta image can be suppressed.

From the above, it is presumed that the toner set according to the present exemplary embodiment can suppress non-uniformity of glossiness of a black image and a magenta image generated in a case of being exposed to an outdoor environment while ensuring low-temperature fixability.

Hereinafter, the details of the toner set according to the present exemplary embodiment will be described. In the following description, common matters between the black toner or the black toner particles and the magenta toner or the magenta toner particles will be simply referred to as “toner or toner particles”, and will be described or specified without being specifically described.

### Toner

Each toner of the toner set according to the present exemplary embodiment (hereinafter, referred to as “toner according to the present exemplary embodiment”) has toner particles. The toner according to the present exemplary embodiment may have an external additive.

### Toner Particles

The toner particles contain an amorphous resin and a crystalline resin as a binder resin, and a colorant. The toner particles may contain a colorant, a release agent, internally-added crosslinked resin particles, and other additives.

Specifically, the black toner particles contain an amorphous resin and a crystalline resin as a binder resin, and a black colorant, and the magenta toner particles contain an amorphous resin and a crystalline resin as a binder resin, and a magenta colorant.

### Binder Resin

An amorphous polyester resin and a crystalline polyester resin are adopted as the binder resin. However, a content of the crystalline polyester resin with respect to the binder resin is 7% by mass or more and 40% by mass or less, and for example, it is preferably 10% by mass or more and 35% by mass or less and more preferably 15% by mass or more and 30% by mass or less.

In a case where the content of the crystalline polyester resin is less than 7% by mass, the low-temperature fixability is deteriorated.

In a case where the content of the crystalline polyester resin is more than 40% by mass, the glossiness of the image of each color is excessively changed, and the non-uniformity of glossiness between the black image and the magenta image cannot be suppressed.

For example, a relationship between a content (% by mass) WC(K) of the crystalline polyester resin with respect to the binder resin in the black toner particles and a content (% by mass) WC(M) of the crystalline polyester resin with respect to the binder resin in the magenta toner particles preferably satisfies the following expression (WC1), more preferably satisfies the following expression (WC2), and still more preferably satisfies the following expression (WC3).

In a case where the following (WC1), the following (WC2), or the following (WC3) is satisfied, a difference in amount of the crystalline polyester resin between the black toner particles and the magenta toner particles is small, a difference in glossiness between the black image and the magenta image after the glossiness is increased in a case where the image is exposed to the outdoor environment is small, and the non-uniformity between the black image and the magenta image can be easily suppressed. In addition, in an indoor high-temperature and high-humidity environment, the difference in glossiness between the black image and the magenta image is reduced, and the non-uniformity between the black image and the magenta image can be easily suppressed.

$$0.90 \leq WC ( K ) / WC ( M ) \leq 1 \text{.10} \qquad Expression ( WC1 )$$

$$0.93 \leq WC ( K ) / WC ( M ) \leq 1.07 \qquad Expression ( WC2 )$$

$$0.96 \leq WC ( K ) / WC ( M ) \leq 1.04 \qquad Expression ( WC3 )$$

The “crystalline” resin indicates that a clear endothermic peak is present in differential scanning calorimetry (DSC) rather than a stepwise change in endothermic amount and specifically indicates that the half-width of the endothermic peak in a case of measurement at a temperature rising rate of 10 (° C./min) is within 10° C.

On the other hand, the “amorphous” resin indicates that the half-width is higher than 10° C., a stepwise change in endothermic amount is shown, or a clear endothermic peak is not recognized.

The amorphous polyester resin will be described.

The amorphous polyester resin is a condensate of a polycarboxylic acid and a polyhydric alcohol, that is, an amorphous polyester resin having a constitutional unit derived from a polyvalent carboxylic acid and a constitutional unit derived from a polyhydric alcohol.

The amorphous polyester resin includes an amorphous polyester resin having, as the constitutional unit derived from a polyvalent carboxylic acid, a constitutional unit derived from a phthalic acid other than terephthalic acid.

The relationship between the mass proportion (% by mass) P(K) of the constitutional unit derived from a phthalic acid other than terephthalic acid in the amorphous polyester resin(S) with respect to the constitutional unit derived from a polyvalent carboxylic acid in the amorphous polyester resin contained in the black toner particles (that is, all amorphous polyester resins contained in the toner particles) and the mass proportion (% by mass) P(M) of the constitutional unit derived from a phthalic acid other than terephthalic acid in the amorphous polyester resin(S) with respect to the constitutional unit derived from a polyvalent carboxylic acid in the amorphous polyester resin contained in the magenta toner particles (that is, all amorphous polyester resins contained in the toner particles), for example, satisfies the following expression (P1), preferably satisfies the following expression (P2) and more preferably satisfies the following expression (P3).

$$10 \leq P ( M ) - P ( K ) \leq 40 \qquad Expression ( P1 )$$

$$15 \leq P ( M ) - P ( K ) \leq 35 \qquad Expression ( P2 )$$

$$20 \leq P ( M ) - P ( K ) \leq 30 \qquad Expression ( P3 )$$

In a case where the value of “P(M)-P(K)” is less than 10% by mass or more than 40% by mass, in both cases, the difference in glossiness between the black image and the magenta image after the glossiness is increased in a case where the image is exposed to the outdoor environment is large, and the non-uniformity between the black image and the magenta image cannot be suppressed.

Here, from the viewpoint of suppressing the non-uniformity of the glossiness between the black image and the magenta image, the mass proportion (% by mass) P(M) of the constitutional unit derived from a phthalic acid other than terephthalic acid which is contained in the magenta toner particles, is, for example, preferably 11% by mass or more and 80% by mass or less, more preferably 15% by mass or more and 50% by mass or less, and still more preferably 20% by mass or more and 35% by mass or less.

For example, it is preferable that the constitutional unit derived from a polyvalent carboxylic acid in the amorphous polyester resin contained in the black toner includes a constitutional unit derived from terephthalic acid as a principle component. In particular, for example, it is preferable that all constitutional units derived from a polyvalent carboxylic acid, excluding the constitutional unit derived from a phthalic acid other than terephthalic acid are constitutional units derived from terephthalic acid.

In addition, the “constitutional unit derived from a polyvalent carboxylic acid includes a constitutional unit derived from terephthalic acid as a principle component” indicates that the constitutional unit derived from terephthalic acid is included in the largest mass proportion among the constitutional units derived from a polyvalent carboxylic acid.

The mass proportion (% by mass) of each constitutional unit derived from a polyvalent carboxylic acid in the amorphous polyester resin (that is, all amorphous polyester resins contained in the toner particles) is measured as follows.

The toner is dissolved in a solvent in which the binder resin is soluble, for example, in tetrahydrofuran (THF), and then insoluble components are removed and dried. In addition, the amorphous polyester resin and the crystalline resin in the binder resin are separated using a solvent in which the amorphous polyester resin is soluble and the crystalline resin is insoluble, by utilizing a difference in solubility of the amorphous polyester resin and the crystalline resin in the solvent. After confirming that there is no endothermic peak derived from the crystalline resin in the obtained amorphous polyester resin using a differential scanning calorimeter (DSC), 1H-NMR measurement is performed. The obtained NMR spectrum is analyzed to obtain a chemical shift and an integral value ratio.

Next, from the chemical shift and the integral value ratio, the mass proportion (% by mass) of each constitutional unit derived from a polyvalent carboxylic acid in the amorphous polyester resin (that is, all amorphous polyester resins contained in the toner particles) can be obtained.

Examples of the phthalic acid other than terephthalic acid include substituted or unsubstituted ortho-phthalic acid and substituted or unsubstituted isophthalic acid. Examples of a substituent include an alkyl group having 1 or more and 4 or less carbon atoms, an ethyl group, and a sulfonic acid group. Specific examples of the phthalic acid other than terephthalic acid include unsubstituted ortho-phthalic acid, unsubstituted isophthalic acid, methyl ortho-phthalic acid, methyl isophthalic acid, diethyl phthalate, and 1,3-benzenedisulfonic acid.

Examples of the terephthalic acid include substituted or unsubstituted terephthalic acid. Examples of a substituent include an alkyl group having 1 or more and 4 or less carbon atoms, an ethyl group, and a sulfonic acid group. Specific examples of the terephthalic acid include unsubstituted terephthalic acid, methyl terephthalic acid, and diethyl terephthalate.

Examples of the polyvalent carboxylic acid other than phthalic acid include aliphatic dicarboxylic acids (for example, oxalic acid, malonic acid, maleic acid, fumaric acid, citraconic acid, itaconic acid, glutaconic acid, succinic acid, alkenyl succinic acid, adipic acid, sebacic acid, and the like), alicyclic dicarboxylic acid (for example, cyclohexanedicarboxylic acid and the like), aromatic dicarboxylic acids (for example, naphthalenedicarboxylic acid and the like), anhydrides of these, and lower alkyl esters (for example, having 1 or more and 5 or less carbon atoms). Among these, for example, an aromatic dicarboxylic acid is preferable as the polyvalent carboxylic acid other than phthalic acid.

As the polyvalent carboxylic acid other than phthalic acid, a carboxylic acid having a valency of 3 or more that has a crosslinked structure or a branched structure may be used in combination with a dicarboxylic acid. Examples of the carboxylic acid having a valency of 3 or more include trimellitic acid, pyromellitic acid, anhydrides of these acids, and lower alkyl esters (for example, having 1 or more and 5 or less carbon atoms) of these acids.

One kind of polyvalent carboxylic acid may be used alone, or two or more kinds of polyvalent carboxylic acids may be used in combination.

A glass transition temperature (Tg) of the amorphous polyester resin is, for example, preferably 50° C. or higher and 80° C. or lower, and more preferably 50° C. or higher and 65° C. or lower.

The glass transition temperature is determined from a DSC curve obtained by differential scanning calorimetry (DSC). More specifically, the glass transition temperature is determined by “extrapolated glass transition onset temperature” described in the method for determining a glass transition temperature in JIS K 7121-1987, “Testing methods for transition temperatures of plastics”.

The weight-average molecular weight (Mw) of the amorphous polyester resin is, for example, preferably 5,000 or more and 1,000,000 or less, and more preferably 7,000 or more and 500,000 or less.

The number-average molecular weight (Mn) of the amorphous polyester resin is, for example, preferably 2,000 or more and 100,000 or less.

The molecular weight distribution Mw/Mn of the amorphous polyester resin is, for example, preferably 1.5 or more and 100 or less, and more preferably 2 or more and 60 or less.

The weight-average molecular weight and the number-average molecular weight are measured by gel permeation chromatography (GPC). By GPC, the molecular weight is measured using GPC. HLC-8120GPC manufactured by Tosoh Corporation as a measurement device, TSKgel Super HM-M (15 cm) manufactured by Tosoh Corporation as a column, and THE as a solvent. The weight-average molecular weight and the number-average molecular weight are calculated using a molecular weight calibration curve plotted using a monodisperse polystyrene standard sample from the measurement results.

The amorphous polyester resin is obtained by a well-known manufacturing method. Specifically, for example, the polyester resin is obtained by a method of setting a polymerization temperature to 180° C. or higher and 230° C. or lower, reducing the internal pressure of a reaction system as necessary, and carrying out a reaction while removing water or an alcohol generated during condensation.

In a case where monomers as raw materials are not dissolved or compatible at the reaction temperature, in order to dissolve the monomers, a solvent having a high boiling point may be added as a solubilizer. In this case, a polycondensation reaction is carried out in a state where the solubilizer is distilled off. In a case where a monomer with poor compatibility takes part in the reaction, for example, the monomer with poor compatibility may be condensed in advance with an acid or an alcohol that is to be polycondensed with the monomer, and then polycondensed together with the principle component.

Here, one kind of amorphous polyester resin may be used alone, or two or more kinds of amorphous polyester resins may be used in combination.

For example, it is preferable that the amorphous polyester resin obtained by using two or more kinds of amorphous polyester resins having different molecular weights in combination. Examples of the case of using two kinds in combination include a case of using a low-molecular-weight form (L form) of the amorphous polyester resin and a high-molecular-weight form (H form) of the amorphous polyester resin in combination.

The low-molecular-weight form (L form) is, for example, preferably an amorphous polyester resin having a weight-average molecular weight of 5,000 or more and 30,000 or less, which is measured by GPC. In a case where the molecular weight is less than 5,000, offset is likely to occur in a high-temperature portion; and in a case where the molecular weight is 30,000 or more, gloss is unlikely to be obtained in a low-temperature portion.

The high-molecular-weight form (H form) is, for example, preferably an amorphous polyester resin having a polymerization average molecular weight of 25,000 or more and 200,000 or less, which is measured by GPC. In a case where the molecular weight is 200,000 or more, gloss in a high-temperature portion is difficult to obtain, or a fixing temperature is increased.

An acid value of the amorphous polyester resin used in combination is, for example, preferably approximately 5 mgKOH/g or more and 20 mgKOH/g or less for the low-molecular-weight form (L form) and approximately 5 mgKOH/g or more and 15 mgKOH/g or less for the high-molecular-weight form (H form).

In a case where two or more kinds of amorphous polyester resins are used in combination, the mass proportions (% by mass) P(K) and P(M) of the constitutional unit derived from a phthalic acid other than terephthalic acid may be obtained by obtaining a mass proportion of the constitutional unit derived from a polyvalent carboxylic acid in all amorphous polyester resins contained in the toner particles.

The crystalline polyester resin will be described.

Examples of the crystalline polyester resin include a polycondensate of polyvalent carboxylic acid and polyhydric alcohol. As the crystalline polyester resin, a commercially available product or a synthetic resin may be used.

Here, since the crystalline polyester resin easily forms a crystal structure, the crystalline polyester resin is, for example, preferably a polycondensate that is not formed of an aromatic-containing polymerizable monomer but is formed of a linear aliphatic polymerizable monomer.

Examples of the polyvalent carboxylic acid include aliphatic dicarboxylic acids (such as oxalic acid, succinic acid, glutaric acid, adipic acid, suberic acid, azelaic acid, sebacic acid, 1,9-nonanedicarboxylic acid, 1,10-decanedicarboxylic acid, 1,12-dodecanedicarboxylic acid, 1,14-tetradecanedicarboxylic acid, and 1,18-octadecanedicarboxylic acid), aromatic dicarboxylic acids (such as dibasic acids such as phthalic acid, isophthalic acid, terephthalic acid, and naphthalene-2,6-dicarboxylic acid), anhydrides of these dicarboxylic acids, and lower alkyl esters (for example, having 1 or more and 5 or less carbon atoms) of these dicarboxylic acids.

As the polyvalent carboxylic acid, a carboxylic acid having a valency of 3 or more that has a crosslinked structure or a branched structure may be used in combination with a dicarboxylic acid. Examples of the trivalent carboxylic acids include aromatic carboxylic acid (for example, 1,2,3-benzenetricarboxylic acid, 1,2,4-benzenetricarboxylic acid, 1,2,4-naphthalenetricarboxylic acid, and the like), anhydrides of these aromatic carboxylic acids, and lower alkyl esters (for example, having 1 or more and 5 or less carbon atoms) of these aromatic carboxylic acids.

As the polyvalent carboxylic acid, a dicarboxylic acid having a sulfonic acid group or a dicarboxylic acid having an ethylenically double bond may be used together with these dicarboxylic acids.

One kind of polyvalent carboxylic acid may be used alone, or two or more kinds of polyvalent carboxylic acids may be used in combination.

Examples of the polyhydric alcohol include an aliphatic diol (for example, a linear aliphatic diol having 7 or more and 20 or less carbon atoms in a main chain portion). Examples of the aliphatic diol include ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,14-eicosanedecanediol. Among the aliphatic diols, for example, 1,8-octanediol, 1,9-nonanediol, or 1,10-decanediol is preferable.

As the polyhydric alcohol, an alcohol having a valency of 3 or more, that forms a crosslinked structure or a branched structure, may be used in combination with the diol.

Examples of the alcohol having a valency of 3 or more include glycerin, trimethylolethane, and trimethylolpropane, pentaerythritol.

One kind of polyhydric alcohol may be used alone, or two or more kinds of polyhydric alcohols may be used in combination.

Here, the content of the aliphatic diol in the polyhydric alcohol may be 80% by mole or more and, for example, preferably 90% by mole or more.

The melting temperature of the crystalline polyester resin is, for example, preferably 50° C. or higher and 100° C. or lower, more preferably 55° C. or higher and 90° C. or lower, and still more preferably 60° C. or higher and 85° C. or lower.

The melting temperature is determined from a DSC curve obtained by differential scanning calorimetry (DSC) by “peak melting temperature” described in the method for determining the melting temperature in JIS K 7121-1987, “Testing methods for transition temperatures of plastics”.

The weight-average molecular weight (Mw) of the crystalline polyester resin is, for example, preferably 6,000 or more and 50,000 or less.

The crystalline polyester resin can be obtained by a well-known manufacturing method, for example, same as the amorphous polyester resin.

A content of the binder resin with respect to the total amount of the toner particles is, for example, preferably 40% by mass or more and 95% by mass or less, more preferably 50% by mass or more and 90% by mass or less, and still more preferably 60% by mass or more and 85% by mass or less.

### Colorant

As the colorant, a black colorant is applied to the black toner particles, and a magenta colorant is applied to the magenta toner particles.

Examples of the black colorant include carbon black, copper oxide, manganese dioxide, aniline black, activated carbon, non-magnetic ferrite, and magnetite.

Examples of the magenta colorant include a β-naphthol-based pigment, an azo lake pigment a quinacridone-based pigment, a disazo-based pigment, a benzimidazolone-based pigment, a disazo condensation-based pigment, a dioxazine-based pigment, and a diketopyrrolopyrrole-based pigment.

Specific examples of the magenta colorant include β-naphthol-based pigments such as C. I. Pigment Red 146, 2, 5, 7, 8, 9, 10, 11, 12, 13, 14, 15, 16, 17, 18, 21, 22, 23, 31, 32, 95, 112, 114, 119, 136, 147, 148, 150, 164, 170, 184, 187, 188, 210, 212, 213, 222, 223, 238, 245, 253, 256, 258, 261, 266, 267, 268, and 269;

azo lake pigments such as C. I. Pigment Red 57:1, 18:1, 48:2, 48:3, 48:4, 48:5, 50:1, 51, 52:1, 52:2, 53:1, 53:2, 53:3, 58:2, 58:4, 64:1, 68, and 200;

quinacridone-based pigments such as C. I. Pigment Red 209, 122, 192, 202, and 207, and C. I. Pigment Violet 19;

disazo-based pigments such as C. I. Pigment Red 37, 38, 41, and 111, and C. I. Pigment Orange 13, 15, 16, 34, and 44;

benzimidazolone-based pigments such as C. I. Pigment Red 171, 175, 176, 185, and 208, C. I. Pigment Violet 32, and C. I. Pigment Orange 36, 60, 62, and 72;

disazo condensation-based pigments such as C. I. Pigment Red 144, 166, 214, 220, 221, 242, 248, and 262, and C. I. Pigment Orange 31;

dioxazine-based pigments such as C. I. Pigment Violet 23 and 37; and

diketopyrrolopyrrole-based pigments such as C. I. Pigment Red 254, 255, 264, and 272, and C. I. Pigment Orange 71 and 73.

The “C. I.” represents Colour Index.

One kind of colorant may be used alone, or two or more kinds of colorants may be used in combination.

As the colorant, a colorant having undergone a surface treatment as necessary may be used, or a dispersant may be used in combination with the colorant. Furthermore, a plurality of kinds of colorants may be used in combination.

The content of the colorant with respect to the total amount of the toner particles is, for example, preferably 1% by mass or more and 30% by mass or less, and more preferably 3% by mass or more and 15% by mass or less.

### Release Agent

Examples of the release agent include hydrocarbon-based wax; natural wax such as carnauba wax, rice wax, and candelilla wax; synthetic or mineral· petroleum-based wax such as montan wax; and ester-based wax such as fatty acid esters and montanic acid esters. The release agent is not limited to the agents.

The melting temperature of the release agent is, for example, preferably 50° C. or higher and 110° C. or lower, and more preferably 60° C. or higher and 100° C. or lower.

The melting temperature is determined from a DSC curve obtained by differential scanning calorimetry (DSC) by “peak melting temperature” described in the method for determining the melting temperature in JIS K 7121-1987, “Testing methods for transition temperatures of plastics”.

The content of the release agent with respect to the total amount of the toner particles is, for example, preferably 1% by mass or more and 20% by mass or less, and more preferably 5% by mass or more and 15% by mass or less.

### Internally-Added Crosslinked Resin Particles

The internally-added crosslinked resin particles refer to resin particles that are contained inside the toner particles have a bridge structure between specific atoms in a polymer structure of the resin particles.

The internally-added crosslinked resin particles are, for example, particles that are present in the toner particles in a state of being incompatible with the binder resin.

Examples of the internally-added crosslinked resin particles include crosslinked resin particles crosslinked by an ionic bond (that is, ionically crosslinked resin particles), and crosslinked resin particles crosslinked by a covalent bond (that is, covalently crosslinked resin particles). Among these internally-added crosslinked resin particles, for example, crosslinked resin particles crosslinked by a covalent bond are preferable.

The styrene-(meth)acrylic copolymer particles as the internally-added crosslinked resin particles are particles containing, as a principle component, a styrene-(meth)acrylic copolymer in resin particles with an amount of 50% by mass or more, for example, preferably 80% by mass or more and more preferably 90% by mass or more, and it is particularly preferable to be particles that are substantially the styrene-(meth)acrylic copolymer.

In addition, the total of styrene-based monomer and (meth)acrylic monomer as monomers constituting the copolymer is, for example, preferably 80% by mass or more, more preferably 90% by mass or more, and particularly preferably 95% by mass or more. The remainder is a crosslinking agent described later.

Examples of the styrene-(meth)acrylic copolymer include a resin obtained by polymerizing the following styrene-based monomer and (meth)acrylic monomer by radical polymerization.

Examples of the styrene-based monomer include styrene, α-methylstyrene, vinylnaphthalene; alkyl-substituted styrene with an alkyl chain, such as 2-methylstyrene, 3-methylstyrene, 4-methylstyrene, 2-ethylstyrene, 3-ethylstyrene, and 4-ethylstyrene; halogen-substituted styrene such as 2-chlorostyrene, 3-chlorostyrene, and 4-chlorostyrene; and fluorine-substituted styrene such as 4-fluorostyrene and 2,5-difluorostyrene. Among the styrene-based monomers, for example, styrene or α-methylstyrene is preferable.

Examples of the (meth)acrylic monomer include (meth)acrylic acid, n-methyl (meth)acrylate, n-ethyl (meth)acrylate, n-propyl (meth)acrylate, n-butyl (meth)acrylate, n-pentyl (meth)acrylate, n-hexyl (meth)acrylate, n-heptyl (meth)acrylate, n-octyl (meth)acrylate, n-decyl (meth)acrylate, n-dodecyl (meth)acrylate, n-lauryl (meth)acrylate, n-tetradecyl (meth)acrylate, n-hexadecyl (meth)acrylate, n-octadecyl (meth)acrylate, isopropyl (meth)acrylate, isobutyl (meth)acrylate, t-butyl (meth)acrylate, isopentyl (meth)acrylate, amyl (meth)acrylate, neopentyl (meth)acrylate, isohexyl (meth)acrylate, isoheptyl (meth)acrylate, isooctyl (meth)acrylate, 2-ethylhexyl (meth)acrylate, phenyl (meth)acrylate, biphenyl (meth)acrylate, diphenylethyl (meth)acrylate, t-butylphenyl (meth)acrylate, terphenyl (meth)acrylate, cyclohexyl (meth)acrylate, t-butylcyclohexyl (meth)acrylate, dimethylaminoethyl (meth)acrylate, diethylaminoethyl (meth)acrylate, methoxyethyl (meth)acrylate, 2-hydroxyethyl (meth)acrylate, 2-carboxyethyl (meth)acrylate, (meth)acrylonitrile, and (meth)acrylamide. Among these, for example, n-butyl (meth)acrylate or 2-carboxyethyl (meth)acrylate is preferable.

In the internally-added crosslinked resin particles, examples of a crosslinking agent for crosslinking the resin include aromatic polyvalent vinyl compounds such as divinylbenzene and divinylnaphthalene; polyvalent vinyl esters of aromatic polyvalent carboxylic acids, such as divinyl phthalate, divinyl isophthalate, divinyl terephthalate, divinyl homophthalate, divinyl trimesate, trivinyl trimesate, divinyl naphthalenedicarboxylate, and divinyl biphenylcarboxylate; divinyl esters of nitrogen-containing aromatic compounds, such as divinyl pyridine dicarboxylate; vinyl esters of unsaturated heterocyclic carboxylic acid compounds, such as vinyl pyromutate, vinyl furan carboxylate, vinyl pyrrole-2-carboxylate, and vinyl thiophene carboxylate; (meth)acrylic acid esters of linear polyhydric alcohols, such as butanediol diacrylate, butanediol dimethacrylate, hexanediol diacrylate, hexanediol dimethacrylate, octanediol diacrylate, octanediol dimethacrylate, nonanediol diacrylate, nonanediol dimethacrylate, decanediol diacrylate, decanediol dimethacrylate, dodecanediol diacrylate, and dodecanediol dimethacrylate; (meth)acrylic acid esters of branched substituted polyhydric alcohols, such as neopentylglycol dimethacrylate and 2-hydroxy, 1,3-diacryloxypropane; and polyvalent vinyl esters of polyvalent carboxylic acids, such as polyethylene glycol di(meth)acrylate, polypropylene polyethylene glycol di(meth)acrylates, divinyl succinate, divinyl fumarate, vinyl maleate, divinyl maleate, divinyl diglycolate, vinyl itaconate, divinyl itaconate, divinyl acetone dicarboxylate, divinyl glutarate, 3,3′-divinylthiodipropionate, divinyl trans-aconitate, trivinyl trans-aconitate, divinyl adipate, divinyl pimelate, divinyl suberate, divinyl azelate, divinyl sebacate, divinyl dodecanedioate, and divinyl brassylate. One kind of crosslinking agent may be used alone, or two or more kinds of crosslinking agents may be used in combination.

Among these crosslinking agents, for example, it is preferable to use a bifunctional alkyl acrylate having an alkylene chain having 6 or more carbon atoms as the crosslinking agent for crosslinking the resin. That is, for example, the internally-added crosslinked resin particles preferably have a bifunctional alkyl acrylate as a constitutional unit, and the number of carbon atoms in the alkylene chain of the bifunctional alkyl acrylate is 6 or more.

By using internally-added crosslinked resin particles having the bifunctional alkyl acrylate as a constitutional unit, in which the number of carbon atoms in the alkylene chain is 6 or more, it is easy to obtain a toner in which the deformation of the toner during fixing is in an appropriate range, and in particular, a toner having favorable low-temperature fixability can be easily obtained. In a case where a crosslinking density of the internally-added crosslinked resin particles is high (that is, a distance between crosslinking points is short), elasticity is too high, but in a case where a bifunctional acrylate having a long alkylene chain is used as the crosslinking agent, the crosslinking density is low (that is, the distance between crosslinking points is long), and it is possible to prevent the elasticity of the internally-added crosslinked resin particles from being too high.

From the viewpoint of adjusting the crosslinking density to an appropriate range, the number of carbon atoms in the alkylene chain of the bifunctional alkyl acrylate is, for example, preferably 6 or more, more preferably 6 or more and 12 or less, and even more preferably 8 or more and 12 or less. More specific examples of the bifunctional alkyl acrylate include 1,6-hexanediol acrylate, 1,6-hexanediol methacrylate, 1,8-octanediol diacrylate, 1,8-octanediol dimethacrylate, 1,9-nonanediol diacrylate, 1,9-nonanediol dimethacrylate, 1,10-decanediol diacrylate, 1,10-decanediol dimethacrylate, 1,12-dodecanediol diacrylate, and 1,12-dodecanediol dimethacrylate, and among these, for example, 1,10-decanediol diacrylate or 1,10-decanediol dimethacrylate is preferable.

Examples of other crosslinking agents include 2-carboxyethyl acrylate, and for example, it is preferable to use at least one of the above-described alkylene glycol diacrylate or 2-carboxyethyl acrylate.

In addition, the fixability of the styrene-(meth)acrylic copolymer particles as the internally-added crosslinked resin particles may be controlled by adjusting the amount of the crosslinking agent contained in a composition. For example, by increasing the amount of the crosslinking agent contained in the composition, it is easy to obtain internally-added crosslinked resin particles having favorable fixability. The content of the crosslinking agent in the composition for forming the internally-added crosslinked resin particles with respect to the total of 100 parts by mass of the styrene-based monomer, the (meth)acrylic monomer, and the crosslinking agent is, for example, preferably 0.3 parts by mass or more and 5.0 parts by mass or less, more preferably 0.5 parts by mass or more and 3.0 parts by mass or less, and still more preferably 0.8 parts by mass or more and 2.5 parts by mass or less.

A glass transition temperature Tg(E) of the internally-added crosslinked resin particles is, for example, preferably 0° C. or higher and 30° C. or lower, and more preferably 5° C. or higher and 25° C. or lower.

The glass transition temperature Tg of the internally-added crosslinked resin particles is determined from a DSC curve obtained by differential scanning calorimetry (DSC). More specifically, the glass transition temperature Tg is determined by “extrapolated glass transition onset temperature” described in the method for determining a glass transition temperature in JIS K 7121-1987, “Testing methods for transition temperatures of plastics”.

The internally-added crosslinked resin particles can be extracted from the toner by dissolving the toner in a solvent in which the binder resin is soluble, for example, in tetrahydrofuran (THF), recovering insoluble components, and then drying the recovered matter.

In the internally-added crosslinked resin particles including the styrene-(meth)acrylic copolymer, the adjustment of Tg(E) can be achieved by adjusting polymerization conditions of the copolymer.

In particular, in order to obtain resin particles in which a composition gradient occurs in the internally-added crosslinked resin particles and a region having a large number of styrene-based units is unevenly distributed on the surface, in a case of producing the resin particles by polymerization of a monomer-containing solution containing a styrene-based monomer and a (meth)acrylic monomer, for example, it is preferable to increase a content ratio of the styrene-based monomer to the (meth)acrylic monomer in the monomer-containing solution as the polymerization proceeds. The “increasing as the polymerization proceeds” typically refers to gradually increasing the content ratio of the styrene-based monomer in the monomer-containing solution, but also includes operations such as gradually increasing the content of the styrene-based monomer in an added monomer in a case of additional adding the monomers to the monomer-containing solution a plurality of times, and increasing the amount of the added styrene-based monomer to gradually increase the concentration of the styrene-based monomer in the monomer-containing solution. For example, in a case of preparing the styrene-(meth)acrylic copolymer by an emulsion polymerization method, the content of the styrene-based monomer in the emulsion can be gradually increased in a case where the emulsion is added dropwise a plurality of times.

Furthermore, the progress of the reaction can be controlled by adjusting polymerization temperature, polymerization time, method of adding a polymerization initiator, and the like in combination.

A content of the internally-added crosslinked resin particles is, for example, preferably 2% by mass or more and 20% by mass or less, and more preferably 3% by mass or more and 15% by mass or less with respect to the entire toner.

An average dispersion size of the internally-added crosslinked resin particles is, for example, preferably 50 nm or more and 300 nm or less, and more preferably 80 nm or more and 250 nm or less.

A method of measuring the average dispersion size of the internally-added crosslinked resin particles is as follows.

The toner particles or the toner is mixed with and embedded in an epoxy resin, and the epoxy resin is solidified. The obtained solidified substance is cut with an ultramicrotome device (UltracutUCT manufactured by Leica Microsystems), thereby producing a thin sample having a thickness of 80 nm or more and 130 nm or less. Next, the obtained thin sample is dyed with ruthenium tetroxide in a desiccator at 30° C. for 3 hours. By using an ultra-high resolution field emission scanning electron microscope (FE-SEM, S-4800 manufactured by Hitachi High-Tech Corporation.), an SEM image of dyed flake sample is obtained. Since ease of dyeing with ruthenium tetroxide varies in the order of the release agent, the styrene-(meth)acrylic resin, and the polyester resin, each component is identified by shade resulting from the degree of dyeing. In a case where it is difficult to distinguish the light and shade due to the condition of the sample or the like, the staining time is adjusted.

In the cross section of the toner particles, the domain of the colorant is smaller than the domain of the release agent and the domain of the resin particles, so that the domains are distinguished by the size.

In the SEM image, 30 toner cross sections having a maximum length of 85% or more of the volume-average particle size of the toner particles are selected, and a total of 100 dyed internally-added crosslinked resin particles (that is, domains thereof) are observed. The maximum length of each domain is measured, the maximum length is regarded as the diameter of the domain, and the diameter is arithmetically averaged to obtain an average equivalent circle diameter. The obtained average equivalent circle diameter is defined as the average dispersion size of the internally-added crosslinked resin particles.

Examples of the adjustment of the average dispersion size of the internally-added crosslinked resin particles include a method of producing the toner particles by aggregation and coalescence and adjusting the volume-average particle size of the internally-added crosslinked resin particles contained in the specific resin particle dispersion used in production; and a method of controlling the average equivalent circle diameter by preparing a plurality of internally-added crosslinked resin particle dispersions with different volume-average particle sizes and using the specific resin particle dispersions in combination.

An average shape factor SF-1 of the internally-added crosslinked resin particles is, for example, preferably 130 or less.

In a case where the average shape factor SF-1 of the internally-added crosslinked resin particles is within the above-described range, the growth of the domain of the crystalline polyester resin is easily suppressed. As a result, transfer unevenness is easily suppressed. In addition, the low-temperature fixability is improved.

The average shape factor SF-1 is obtained by the following equation.

$$SF - 1 = ( ML / A ) \times ( π / 4 ) \times 100$$

In the above equation, ML represents an absolute maximum length of the toner particles, and A represents a projected area of the toner particles.

Specifically, a sample is prepared in the same manner as in the measurement of the average dispersion size of the internally-added crosslinked resin particles described above. In the SEM image, 30 toner cross sections having a maximum length of 85% or more of the volume-average particle size of the toner particles are selected, and a total of 100 dyed internally-added crosslinked resin particles are observed. The observed SEM image is taken into an image analysis processing system Luzex (manufactured by NIRECO), the maximum length and the projected area of 100 particles are obtained, average shape factors are calculated from the above equation, and an average value thereof are obtained. The obtained average value is defined as the average shape factor SF-1 of the internally-added crosslinked resin particles.

### Method for Producing Internally-Added Crosslinked Resin Particles

As a method for producing the internally-added crosslinked resin particles, for example, a known method such as an emulsion polymerization method, a melt-kneading method using a Banbury mixer or a kneader, a suspension polymerization method, and a spray drying method is adopted. For example, an emulsion polymerization method is preferable in order to unevenly distribute the units derived from the styrene-based monomer on the surface of the particles.

In the method for producing the internally-added crosslinked resin particles, for example, it is preferable to use a styrene-based monomer and a (meth)acrylic monomer as monomers and to carry out polymerization in the presence of a crosslinking agent.

In the method for producing the internally-added crosslinked resin particles, for example, it is preferable to perform emulsion polymerization a plurality of times.

Hereinafter, the method for producing the internally-added crosslinked resin particles will be described in more detail.

For example, it is preferable that the method for producing the internally-added crosslinked resin particles includes a step (emulsion preparation step) of obtaining an emulsion containing a monomer, a crosslinking agent, a surfactant, and water; a step (first emulsion polymerization step) of adding a polymerization initiator to the emulsion and then heating to polymerize the monomer; and a step (second emulsion polymerization step) of adding an emulsion containing a monomer and a crosslinking agent to the reaction solution after the first emulsion polymerization step, and then heating to polymerize the monomers.

Furthermore, in the second emulsion polymerization step, in order to adjust the composition of the surface of the particles, after preparing the emulsion by changing the ratio of the styrene-based monomer and the (meth)acrylic monomer, the emulsion may be added a plurality of times.

### Emulsion Preparation Step

The emulsion preparation step is a step of obtaining an emulsion containing a monomer, a crosslinking agent, a surfactant, and water.

For example, it is preferable to obtain the emulsion by emulsifying a monomer, a crosslinking agent, a surfactant, and water by using an emulsifying machine.

Examples of the emulsifying machine include a rotary stirrer equipped with a propeller type, anchor type, paddle type, or turbine type stirring blade; a stationary mixer such as a static mixer; a rotor and stator type emulsifying machine such as a homogenizer and Clare mix; a mill type emulsifying machine having grinding function; a high-pressure emulsifying machine such as a Manton-Gaulin-type pressure emulsifying machine; a high-pressure nozzle type emulsifying machine that causes cavitation under high pressure; a high-pressure impact-type emulsifying machine, such as a microfluidizer, that generates shearing force by causing collision of liquids under high pressure; an ultrasonic emulsifying machine that causes cavitation by using ultrasonic waves; and a membrane emulsifying machine that performs emulsification through pores.

As the monomers, for example, it is preferable to use a styrene-based monomer and a (meth)acrylic monomer.

As the crosslinking agent, the aforementioned crosslinking agent is used.

Examples of the surfactant include an anionic surfactant based on a sulfuric acid ester salt, a sulfonate, a phosphoric acid ester, soap, and the like; a cationic surfactant such as an amine salt-type cationic surfactant and a quaternary ammonium salt-type cationic surfactant; a nonionic surfactant based on polyethylene glycol, an alkylphenol ethylene oxide adduct, and a polyhydric alcohol, and the like. The nonionic surfactant may be used in combination with an anionic surfactant or a cationic surfactant. Among these surfactants, for example, an anionic surfactant is preferable. One kind of surfactant may be used alone, or two or more kinds of surfactants may be used in combination.

The emulsion may contain a chain transfer agent. The chain transfer agent is not particularly limited. As the chain transfer agent, a compound having a thiol component can be used. Specifically, for example, alkyl mercaptans such as hexyl mercaptan, heptyl mercaptan, octyl mercaptan, nonyl mercaptan, decyl mercaptan, and dodecyl mercaptan are preferable.

A mass ratio of the styrene-based monomer to the (meth)acrylic monomer in the emulsion (styrene-based monomer/(meth)acrylic monomer) is, for example, preferably 0.2 or more and 1.1 or less.

In addition, the content of the crosslinking agent with respect to the entire emulsion is, for example, preferably 0.5% by mass or more and 3% by mass or less.

### First Emulsion Polymerization Step

The first emulsion polymerization step is a step of adding a polymerization initiator to the emulsion and heating the emulsion to polymerize the monomers.

Here, in the polymerization, for example, it is preferable to stir the emulsion (reaction solution) containing the polymerization initiator with a stirrer.

Examples of the stirrer include a rotary stirrer equipped with a propeller type, anchor type, paddle type, or turbine type stirring blade.

As the polymerization initiator, for example, it is preferable to use ammonium persulfate.

### Second Emulsion Polymerization Step

The second emulsion polymerization step is a step of adding an emulsion containing a monomer to the reaction solution obtained after the first emulsion polymerization step, and heating to polymerize the monomer.

In the polymerization, for example, it is preferable to stir the reaction solution in the same manner as in the first emulsification polymerization step.

In the present step, the ratio of the styrene-based monomer and the (meth)acrylic monomer in the emulsion containing the monomers may be changed, and the emulsion may be added by dividing the emulsion into a plurality of times.

For example, it is preferable to obtain the emulsion containing monomers by emulsifying monomers, a surfactant, and water by using an emulsifying machine.

### Other Additives

Examples of other additives include well-known additives such as a magnetic material, a charge control agent, and inorganic powder. The additives are incorporated into the toner particles as internal additives.

Characteristics of Toner Particles and the like

For example, it is preferable that a tetrahydrofuran-insoluble amount (% by mass) WT(K) of the black toner particles and a tetrahydrofuran-insoluble amount (% by mass) WT(M) of the magenta toner particles are each 15% by mass or more and 40% by mass or less, and a relationship between the tetrahydrofuran-insoluble amounts WT(K) and WT(M) satisfies the following expression (WT1).

In addition, for example, it is preferable that the relationship between the tetrahydrofuran-insoluble amount (% by mass) WT(K) of the black toner particles and the tetrahydrofuran-insoluble amount (% by mass) WT(M) of the magenta toner particles satisfies the following expression (WT2).

$$W T ( K ) > WT ( M ) . \qquad Expression ( WT1 )$$

$$2 \leq WT ( K ) - WT ( M ) \leq 10 \qquad Expression ( WT2 )$$

In a case where the tetrahydrofuran-insoluble amounts (% by mass) of the black toner particles and the magenta toner particles are each 10% by mass or more and 40% by mass or less, and the relationship between the tetrahydrofuran-insoluble amount (% by mass) WT(K) of the black toner particles and the tetrahydrofuran-insoluble amount (% by mass) WT(M) of the magenta toner particles satisfies the above-described relationship, the glossiness of the black image is less likely to increase and the glossiness of the magenta image is likely to increase in a case of being exposed to the outdoor environment. As a result, it is easy to suppress the non-uniformity of the glossiness between the black image and the magenta image. For the reason, it is considered that the crystalline polyester resin is suppressed from appearing on the image surface in the black image formed of the black toner as compared with the magenta image formed of the magenta toner, due to a tetrahydrofuran-insoluble component.

The tetrahydrofuran-insoluble amounts (% by mass) of the black toner particles and the magenta toner particles are, for example, more preferably 15% by mass or more and 35% by mass or less, and still more preferably 18% by mass or more and 30% by mass or less.

The difference (value of “WT(K)-WT(M)”) between the tetrahydrofuran-insoluble amount (% by mass) WT(K) of the black toner particles and the tetrahydrofuran-insoluble amount (% by mass) WT(M) of the magenta toner particles is, for example, more preferably 2 or more and 10 or less, and still more preferably 3 or more and 8 or less.

For example, it is preferable that the tetrahydrofuran-insoluble component in the black toner particles and the magenta toner particles includes a resin having a glass transition temperature Tg of 0° C. or higher and 30° C. or lower (for example, preferably 5° C. or higher and 30° C. or lower).

In addition, the resin having a glass transition temperature Tg of 0° C. or higher and 30° C. or lower is, for example, preferably a styrene-(meth)acrylic copolymer. The styrene-(meth)acrylic copolymer corresponds to, for example, a crosslinked styrene-(meth)acrylic copolymer in the toner particles, such as the internally-added crosslinked resin particles.

In a case where the tetrahydrofuran-insoluble component includes the resin having a glass transition temperature Tg of 0° C. or higher and 30° C. or lower (particularly, the styrene-(meth)acrylic copolymer), it is easy to suppress the non-uniformity in the glossiness between the black image and the magenta image. For the reason, it is considered that the resin having a glass transition temperature Tg of 0° C. or higher and 30° C. or lower, as the tetrahydrofuran-insoluble component, is suppressed from appearing on the image surface in the black image formed of the black toner as compared with the magenta image formed of the magenta toner.

A method of measuring the tetrahydrofuran-insoluble component is as follows.

(1) 0.25 g of the toner is weighed, 40 mL of tetrahydrofuran is added thereto, and the mixture is mixed and stirred for 3 hours.

(2) Thereafter, the mixed solution obtained in (1) is separated by a centrifuge at 2,000 revolutions per minute (rpm) for 30 minutes.

(3) 5 mL of the supernatant liquid after the centrifugation obtained in (2) is weighed, and transferred to an aluminum dish, and tetrahydrofuran is evaporated and dried in a vacuum dryer adjusted to 50° C.

(4) From a difference in mass of the aluminum dish before and after the drying, the tetrahydrofuran-insoluble component excluding an inorganic substance is calculated according to the following expression.

$$Tetrahydrofuran - insoluble component [ \% ] = \{ 0.25 - [ ( Mass of supernatant and aluminum dish ) - ( Mass of aluminum dish after drying ) \times 8 ] \} / 0.25 \times 100$$

A mass proportion of the resin having a glass transition temperature Tg of 0° C. or higher and 30° C. or lower in the tetrahydrofuran-insoluble component is, for example, preferably 5% by mass or more and 60% by mass or less, and more preferably 10% by mass or more and 50% by mass or less.

The toner particles may be toner particles that have a single-layer structure or toner particles having a so-called core/shell structure that is configured with a core portion (core particle) and a coating layer (shell layer) coating the core portion.

Here, the toner particles having a core/shell structure may, for example, be configured with a core portion that is configured with a binder resin, a colorant, and other additives used as necessary, such as a release agent, and a coating layer that is configured with a binder resin.

The volume-average particle size (D50v) of the toner particles is, for example, preferably 2 μm or more and 10 μm or less, and more preferably 4 μm or more and 8 μm or less.

The various average particle sizes and various particle size distribution indexes of the toner particles are measured using COULTER MULTISIZER II (manufactured by Beckman Coulter, Inc.) and using ISOTON-II (manufactured by Beckman Coulter, Inc.) as an electrolytic solution.

For measurement, a measurement sample in an amount of 0.5 mg or more and 50 mg or less is added to 2 ml of a 5% aqueous solution of a surfactant (for example, preferably sodium alkylbenzene sulfonate) as a dispersant. The obtained solution is added to an electrolytic solution in a volume of 100 ml or more and 150 ml or less.

The electrolytic solution in which the sample is suspended is subjected to a dispersion treatment for 1 minute with an ultrasonic disperser, and the particle size distribution of particles having a particle size in a range of 2 μm or more and 60 μm or less is measured using COULTER MULTISIZER II with an aperture having an aperture size of 100 μm. The number of particles to be sampled is 50,000.

For the particle size range (channel) divided based on the measured particle size distribution, a cumulative volume distribution and a cumulative number distribution are plotted from small-sized particles. The particle size at which the cumulative percentage of particles is 16% is defined as volume-average particle size D16v and a number-based particle size D16p. The particle size at which the cumulative percentage of particles is 50% is defined as volume-average particle size D50v and a cumulative number-average particle size D50p. The particle size at which the cumulative percentage of particles is 84% is defined as volume-average particle size D84v and a number-based particle size D84p.

By using these, a volume particle size distribution index (GSDv) is calculated as (D84v/D16v)^{1/2}, and a number particle size distribution index (GSDp) is calculated as (D84p/D16p)^{1/2}.

The average circularity of the toner particles is, for example, preferably 0.90 or more and 1.00 or less, and more preferably 0.92 or more and 0.98 or less.

The average circularity of the toner particles is determined by (equivalent circular perimeter)/(perimeter) [(perimeter of circle having the same projected area as particle image)/(perimeter of projected particle image)]. Specifically, the average circularity is a value measured by the following method.

First, toner particles as a measurement target are collected by suction, and a flat flow of the particles is formed. Thereafter, an instant flash of strobe light is emitted to the particles, and the particles are imaged as a still image. By using a flow-type particle image analyzer (FPIA-3000 manufactured by Sysmex Corporation) performing image analysis on the particle image, the average circularity is determined. The number of samplings for determining the average circularity is 3,500.

In a case where a toner contains the external additive, the toner (developer) as a measurement target is dispersed in water containing a surfactant, then the dispersion is treated with ultrasonic waves such that the external additive is removed, and the toner particles are collected.

### External Additive

Examples of the external additive include inorganic particles. Examples of the inorganic particles include particles such as SiO₂, TiO₂, Al₂O₃, SrTiO₃, CuO, ZnO, SnO₂, CeO₂, Fe₂O₃, MgO, BaO, CaO, K₂O, Na₂O, ZrO₂, CaO, SiO₂, K₂O, (TiO₂) n, Al₂O₃·2SiO₂, CaCO₃, MgCO₃, BaSO₄, and MgSO₄.

The surface of the inorganic particles as an external additive may have undergone, for example, a hydrophobization treatment. The hydrophobization treatment is performed, for example, by dipping the inorganic particles in a hydrophobizing agent. The hydrophobizing agent is not particularly limited, and examples thereof include a silane-based coupling agent, silicone oil, a titanate-based coupling agent, and an aluminum-based coupling agent. One kind of each of the agents may be used alone, or two or more kinds of the agents may be used in combination.

Usually, the amount of the hydrophobic agent is, for example, 1 part by mass or more and 10 parts by mass or less with respect to 100 parts by mass of the inorganic particles.

Examples of the external additive also include resin particles (resin particles such as polystyrene, polymethylmethacrylate (PMMA), and melamine resins), a cleaning activator (for example, and a metal salt of a higher fatty acid represented by zinc stearate or fluorine-based polymer particles).

The amount of the external additive externally added with respect to the toner particles is, for example, preferably 0.01% by mass or more and 10% by mass or less, and more preferably 0.01% by mass or more and 6.0% by mass or less.

### Thermal Analysis Characteristics of Toner

In a thermal analysis measurement by differential scanning calorimetry (DSC), for example, the toner preferably has a peak (an exothermic peak) that is maximal in a range of lower than 50° C. or higher than 70° C. (for example, preferably in a range of 55° C. or higher and 65° C. or lower) at a second temperature rise. As a result, crystallization of the crystalline polyester resin in the image is likely to proceed at the time of temperature rise, and an excessive increase in glossiness of the image can be suppressed. As a result, it is easy to suppress the non-uniformity of the glossiness between the black image and the magenta image.

In order to obtain the above-described thermal analysis characteristics of the toner, for example, the melting point or the amount of the crystalline polyester resin is adjusted. In addition, for example, a crystal nucleus agent that promotes the crystallization may be added.

The thermal analysis measurement by differential scanning calorimetry (DSC) is performed on the toner to be measured in accordance with ASTM D 3418-8 (2008). Specifically, the measurement is performed as follows.

First, 10 mg of the toner to be measured is set in a differential scanning calorimeter (DSC-60 Plus manufactured by Shimadzu Corporation) equipped with an automatic tangent processing system, the temperature is raised from room temperature (25° C.) to 200° C. with a temperature rising rate of 10° C./min, and the temperature is maintained at 200° C. for 5 minutes to obtain a temperature rising spectrum (DSC curve) at the first temperature rise.

Subsequently, the temperature is lowered to 50° C. with a cooling rate of −10° C./min using liquid nitrogen, and the temperature is maintained at 50° C. for 2 hours.

Thereafter, the temperature is raised from 50° C. to 200° C. with a temperature rising rate of 10° C./min, and a temperature rising spectrum (DSC curve) at the second temperature rise is obtained.

The detected maximal peak (that is, the exothermic peak) is specified in the temperature rising spectrum (DSC curve) during the second temperature rise. Here, the endothermic peak indicates a peak having a half-width of 15° C. or lower.

It is determined whether or not the apex of the maximal peak is in a range of 50° C. or higher and 70° C. or lower (for example, preferably in a range of 55° C. or higher and 65° C. or lower).

### Manufacturing Method of Toner

Next, the manufacturing method of the toner according to the present exemplary embodiment will be described.

The toner according to the present exemplary embodiment is obtained by manufacturing toner particles and then externally adding external additives to the toner particles.

The toner particles may be manufactured by any of a dry manufacturing method (for example, a kneading and pulverizing method or the like) or a wet manufacturing method (for example, an aggregation and coalescence method, a suspension polymerization method, a dissolution suspension method, or the like). The manufacturing method of the toner particles is not particularly limited to these manufacturing methods, and a well-known manufacturing method is adopted.

Among the above methods, for example, the aggregation and coalescence method may be used for obtaining toner particles.

Specifically, in a case where the toner particles are manufactured by an aggregation and coalescence method, for example, the toner particles are manufactured through a step (first aggregated particle-forming step) of forming first aggregated particles by mixing a first amorphous resin particle dispersion in which first amorphous resin particles as a binder resin are dispersed, a crystalline resin particle dispersion in which crystalline resin particles as a binder resin are dispersed, an internally-added crosslinked resin particle dispersion in which internally-added crosslinked resin particles are dispersed, a colorant dispersion in which a colorant is dispersed, and a release agent particle dispersion in which particles of a release agent (hereinafter, also referred to as “release agent particles”) are dispersed, and aggregating the particles and the colorant in the obtained dispersion; a step (second aggregated particle-forming step) of forming second aggregated particles by, after obtaining the first aggregated particle dispersion in which the first aggregated particles are dispersed, adding second amorphous resin particles as a binder resin to the first aggregated particle dispersion, and aggregating the second amorphous resin particles on a surface of the first aggregated particles; and a step (coalescence step) of heating the second aggregated particle dispersion in which the second aggregated particles are dispersed to allow the second aggregated particles to undergo coalescence and to form toner particles.

Here, as the first amorphous resin particles and the second amorphous resin particles, amorphous polyester resin particles are applied; and as the crystalline resin particles, crystalline polyester resin particles are applied.

The present aggregation and coalescence method will be described as a method for producing toner particles containing a binder resin, a colorant, a release agent, and internally-added crosslinked resin particles; but the release agent and the internally-added crosslinked resin particles are components to be contained in the toner particles as necessary.

Hereinafter, each of the steps will be described in detail.

### Each Dispersion Preparing Step

First, each dispersion to be used in the aggregation and coalescence method is prepared. Specifically, the first amorphous resin particle dispersion in which first amorphous resin particles as a binder resin are dispersed, a crystalline resin particle dispersion in which crystalline resin particles are dispersed, an internally-added crosslinked resin particle dispersion in which internally-added crosslinked resin particles are dispersed, a colorant dispersion in which a colorant is dispersed, a second amorphous resin particle dispersion in which second amorphous resin particles as a binder resin are dispersed, and a release agent particle dispersion in which release agent particles are dispersed are prepared.

In each dispersion preparing step, the first amorphous resin particles, the second amorphous resin particles, and the crystalline resin particles will be referred to as “resin particles” in the following description.

The resin particle dispersion is prepared, for example, by dispersing the resin particles in a dispersion medium by using a surfactant.

Examples of the dispersion medium used for the resin particle dispersion include an aqueous medium.

Examples of the aqueous medium include distilled water, water such as deionized water, alcohols, and the like. One kind of each of the media may be used alone, or two or more kinds of the media may be used in combination.

Examples of the surfactant include an anionic surfactant based on a sulfuric acid ester salt, a sulfonate, a phosphoric acid ester, soap, and the like; a cationic surfactant such as an amine salt-type cationic surfactant and a quaternary ammonium salt-type cationic surfactant; a nonionic surfactant based on polyethylene glycol, an alkylphenol ethylene oxide adduct, and a polyhydric alcohol, and the like. Among these, an anionic surfactant and a cationic surfactant are particularly mentioned. The nonionic surfactant may be used in combination with an anionic surfactant or a cationic surfactant.

One kind of surfactant may be used alone, or two or more kinds of surfactants may be used in combination.

As for the resin particle dispersion, examples of the method for dispersing the resin particles in the dispersion medium include general dispersion methods such as a rotary shearing homogenizer, a ball mill having media, a sand mill, and a dyno mill. Depending on the type of resin particles, the resin particles may be dispersed in the resin particle dispersion by using, for example, a transitional phase inversion emulsification method.

The transitional phase inversion emulsification method is a method of dissolving a resin to be dispersed in a hydrophobic organic solvent in which the resin is soluble, adding a base to an organic continuous phase (O phase) for causing neutralization, and then adding an aqueous medium (W phase), such that the resin undergoes conversion (so-called phase inversion) from W/O to O/W, turns into a discontinuous phase, and is dispersed in the aqueous medium in the form of particles.

The volume-average particle size of the resin particles dispersed in the resin particle dispersion is, for example, preferably 0.01 μm or more and 1 μm or less, more preferably 0.08 μm or more and 0.8 μm or less, and still more preferably 0.1 μm or more and 0.6 μm or less.

For determining the volume-average particle size of the resin particles, a particle size distribution is measured using a laser diffraction type particle size distribution analyzer (for example, LA-700 manufactured by HORIBA, Ltd.), a volume-based cumulative distribution from small-sized particles is drawn for the particle size range (channel) divided using the particle size distribution, and the particle size of particles accounting for cumulative 50% of all particles is measured as a volume-average particle size D50v. For particles in other dispersions, the volume-average particle size is measured in the same manner.

The content of the resin particles contained in the resin particle dispersion is, for example, preferably 5% by mass or more and 50% by mass or less, and more preferably 10% by mass or more and 40% by mass or less.

For example, the colorant dispersion, the release agent particle dispersion, and the internally-added crosslinked resin particle dispersion are also prepared in the same manner as the resin particle dispersion. That is, the volume-average particle size of the particles, the dispersion medium, the dispersion method, and the content of the particles in the resin particle dispersion are also applied to the colorant to be dispersed in the colorant dispersion, the release agent particles to be dispersed in the release agent particle dispersion, and the internally-added crosslinked resin particles to be dispersed in the internally-added crosslinked resin particle dispersion.

### First Aggregated Particle-Forming Step

Next, the first amorphous resin particle dispersion, the crystalline resin particle dispersion, the internally-added crosslinked resin particle dispersion, the colorant dispersion, and the release agent particle dispersion are mixed with each other.

Next, in the mixed dispersion, the first amorphous resin particles, the crystalline resin particles, the internally-added crosslinked resin particles, the colorant, and the release agent particles are hetero-aggregated to form first aggregated particles containing the first amorphous resin, the internally-added crosslinked resin particles, the colorant, and the release agent particles.

Specifically, for example, an aggregating agent is added to a dispersion obtained by mixing the first amorphous resin particle dispersion, the crystalline resin particle dispersion, the internally-added crosslinked resin particle dispersion, the colorant dispersion, and the release agent particle dispersion; the pH of the mixed dispersion is adjusted to acidic (for example, pH of 2 or more and 5 or less); a dispersion stabilizer is added thereto as necessary; the temperature is set to a temperature region of 20° C. or higher and 50° C. or lower; and the particles dispersed in the mixed dispersion are aggregated to form the first aggregated particles.

In the first aggregated particle-forming step, for example, in a state where the mixed dispersion is stirred with a rotary shearing homogenizer, the aggregating agent may be added thereto at room temperature (for example, 25° C.), the pH of the mixed dispersion may be adjusted such that the dispersion is acidic (for example, pH of 2 or higher and 5 or lower), a dispersion stabilizer may be added to the dispersion as necessary, and then the dispersion may be heated.

Examples of the aggregating agent include a surfactant having polarity opposite to the polarity of the surfactant used as a dispersant added to the mixed dispersion, an inorganic metal salt, and a metal complex having a valency of 2 or higher. In particular, in a case where a metal complex is used as the aggregating agent, the amount of the surfactant used is reduced, and the charging characteristics are improved.

An additive that forms a complex or a bond similar to the complex with a metal ion of the aggregating agent may be used as necessary. As such an additive, a chelating agent is used.

Examples of the inorganic metal salt include metal salts such as calcium chloride, calcium nitrate, barium chloride, magnesium chloride, zinc chloride, aluminum chloride, and aluminum sulfate; and inorganic metal salt polymers such as polyaluminum chloride, polyaluminum hydroxide, and calcium polysulfide.

As the chelating agent, a water-soluble chelating agent may also be used. Examples of the chelating agent include oxycarboxylic acids such as tartaric acid, citric acid, and gluconic acid, iminodiacetic acid (IDA), nitrilotriacetic acid (NTA), and ethylenediaminetetraacetic acid (EDTA).

The amount of the chelating agent added is, for example, preferably 0.01 parts by mass or more and 5.0 parts by mass or less, and more preferably 0.1 parts by mass or more and less than 3.0 parts by mass with respect to 100 parts by mass of the resin particles (the first amorphous resin particles, the second amorphous resin particles, and the internally-added crosslinked resin particles).

### Second Aggregated Particle-Forming Step

Next, after obtaining the first aggregated particle dispersion in which the first aggregated particles are dispersed, a second amorphous resin particle dispersion in which the second amorphous resin particles are dispersed is added to the first aggregated particle dispersion.

The second amorphous resin particles may be the same as or different from the first amorphous resin.

Next, the second amorphous resin particles are aggregated on the surface of the first aggregated particles in the dispersion of the first aggregated particles and the second amorphous resin particles. In this case, by further adding the release agent particle dispersion, the second amorphous resin particles and the release agent particles may be aggregated on the surface of the first aggregated particles. Specifically, for example, in the first aggregated particle-forming step, in a case where the first aggregated particles reach a target particle size, the second amorphous resin particle dispersion is added to the first aggregated particle dispersion, and the mixture is heated at a temperature equal to or lower than the glass transition temperature of the second amorphous resin particles.

By setting the pH of the dispersion in a range of, for example, about 6.5 or more and 8.5 or less, the progress of aggregation is stopped.

In this way, the second aggregated particles are obtained in which the second amorphous resin particles are aggregated so as to adhere to the surface of the first aggregated particles.

### Coalescence Step

Next, the second aggregated particle dispersion in which the second aggregated particles are dispersed is heated to, for example, a temperature equal to or higher than the glass transition temperatures of the first and second amorphous resin particles (for example, a temperature higher than the glass transition temperatures of the first and second amorphous resin particles by 10° C. to 30° C.) such that the second aggregated particles coalesce, thereby forming toner particles.

The toner particles are obtained through the above steps.

In the aggregation and coalescence method described above, the first aggregated particles may be coalesced to form the toner particles without performing the second aggregated particle-forming step. In addition, the second aggregated particle-forming step may be repeated a plurality of times.

In addition, in the second aggregated particle-forming step, a crystalline resin particle dispersion may be used, or an internally-added crosslinked resin particle dispersion may be used.

After the coalescence step, the toner particles formed in a solution undergo a known washing step, solid-liquid separation step, and drying step, thereby obtaining dry toner particles.

The washing step is not particularly limited. However, in view of charging properties, displacement washing may be thoroughly performed using deionized water. The solid-liquid separation step is not particularly limited. However, in view of productivity, suction filtration, pressure filtration, or the like may be performed. Furthermore, the method of the drying step is not particularly limited. However, in view of productivity, freeze drying, flush drying, fluidized drying, vibratory fluidized drying, or the like may be performed.

For example, by adding an external additive to the obtained dry toner particles and mixing the external additive and the toner particles together, the toner according to the present exemplary embodiment is manufactured. The mixing may be performed, for example, using a V blender, a Henschel mixer, a Lödige mixer, or the like. Furthermore, coarse particles of the toner may be removed as necessary by using a vibratory sieving machine, a pneumatic sieving machine, or the like.

### Electrostatic Charge Image Developer Set

The electrostatic charge image developing toner set according to the present exemplary embodiment includes a first electrostatic charge image developer that contains the black toner in the electrostatic charge image developing toner set according to the present exemplary embodiment, and a second electrostatic charge image developer that contains the magenta toner in the electrostatic charge image developing toner set according to the present exemplary embodiment.

Each developer of the electrostatic charge image developer set according to the present exemplary embodiment may be a one-component developer that contains each developer and only the toner in the toner set according to the present exemplary embodiment, or a two-component developer that is obtained by mixing the toner and a carrier together.

The carrier is not particularly limited, and examples thereof include known carriers. Examples of the carrier include a coated carrier obtained by coating the surface of a core material consisting of magnetic powder with a coating resin; a magnetic powder dispersion-type carrier obtained by dispersing magnetic powder in a matrix resin and mixing the powder and the resin together; and a resin impregnation-type carrier obtained by impregnating porous magnetic powder with a resin.

Each of the magnetic powder dispersion-type carrier and the resin impregnation-type carrier may be a carrier obtained by coating a core material, that are particles configuring the carrier, with a coating resin.

Examples of the magnetic powder include magnetic metals such as iron, nickel, and cobalt; and magnetic oxides such as ferrite and magnetite.

Examples of the coating resin and the matrix resin include a styrene· (meth)acrylic acid resin; polyolefin-based resins such as a polyethylene resin and a polypropylene resin; polyvinyl-based or polyvinylidene-based resins such as polystyrene, a (meth)acrylic resin, polyacrylonitrile, polyvinyl acetate, polyvinyl alcohol, polyvinyl butyral, polyvinyl chloride, polyvinylcarbazole, polyvinyl ether, or polyvinyl ketone; a vinyl chloride· vinyl acetate copolymer; a straight silicone resin consisting of an organosiloxane bond or a modified product thereof; a fluororesin such as polytetrafluoroethylene, polyvinyl fluoride, polyvinylidene fluoride, or polychlorotrifluoroethylene; polyester; polyurethane; polycarbonate; an amino resin such as a urea· formaldehyde resin; and an epoxy resin.

For example, the coating resin and the matrix resin preferably contain a (meth)acrylic resin, more preferably contain 50% by mass or more of the (meth)acrylic resin with respect to the total mass of the resin, and still more preferably contain 80% by mass or more of the (meth)acrylic resin with respect to the total mass of the resin.

In particular, for example, the coating resin and the matrix resin preferably contain an alicyclic (meth)acrylic resin as the (meth)acrylic resin.

The coating resin and the matrix resin may contain other additives such as conductive particles.

Examples of the conductive particles include metals such as gold, silver, and copper, and particles such as carbon black, titanium oxide, zinc oxide, tin oxide, barium sulfate, aluminum borate, and potassium titanate.

The surface of the core material is coated with a coating resin, for example, by a coating method using a solution for forming a coating layer obtained by dissolving the coating resin and various additives, that are used as necessary, in an appropriate solvent, and the like. The solvent is not particularly limited, and may be selected in consideration of the type of the coating resin used, coating suitability, and the like.

Specifically, examples of the resin coating method include a dipping method of dipping the core material in the solution for forming a coating layer; a spray method of spraying the solution for forming a coating layer to the surface of the core material; a fluidized bed method of spraying the solution for forming a coating layer to the core material that is floating by an air flow; and a kneader coater method of mixing the core material of the carrier with the solution for forming a coating layer in a kneader coater and removing solvents.

The mixing ratio (mass ratio) between the toner and the carrier, represented by toner: carrier, in the two-component developer is, for example, preferably 1:100 to 30:100, and more preferably 3:100 to 20:100.

### Image Forming Apparatus and Image Forming Method

The image forming apparatus and image forming method according to the present exemplary embodiment will be described.

The image forming apparatus according to the present exemplary embodiment includes a first image forming unit that forms a black image using the black toner in the electrostatic charge image developing toner set according to the present exemplary embodiment; a second image forming unit that forms a magenta image using the magenta toner in the electrostatic charge image developing toner set according to the present exemplary embodiment; a transfer device that transfers the black image and the magenta image onto a recording medium; and a fixing device that fixes the black image and the magenta image on the recording medium.

The image forming apparatus according to the present exemplary embodiment may have an aspect in which the first or second image forming unit has an image holder, a charging device that charges a surface of the image holder, an electrostatic charge image forming device that forms an electrostatic charge image on the charged surface of the image holder, and a developing device that develops the electrostatic charge image formed on the surface of the image holder by an electrostatic charge image developer as a toner image.

The image forming apparatus according to the present exemplary embodiment may have an aspect in which the image forming apparatus has an image holder, a charging device that charges a surface of the image holder, an electrostatic charge image forming device that forms an electrostatic charge image on the charged surface of the image holder, and as the first or second image forming unit, a first or second developing device that develops the electrostatic charge image formed on the surface of the image holder by an electrostatic charge image developer as a toner image.

With the image forming apparatus according to the present exemplary embodiment, an image forming method (image forming method according to the present exemplary embodiment) including a first image forming step of forming a black image by the black toner in the electrostatic charge image developing toner set according to the present exemplary embodiment, a second image forming step of forming a magenta image by the magenta toner in the electrostatic charge image developing toner set according to the present exemplary embodiment, a transfer step of transferring the black image and the magenta image onto a recording medium, and a fixing step of fixing the black image and the magenta image onto the recording medium is performed.

As the image forming apparatus according to the present exemplary embodiment, well-known image forming apparatuses are used, such as a direct transfer-type apparatus that transfers the toner image (in the present exemplary embodiment, the black image and the magenta image) formed on the surface of the image holder directly to a recording medium; an intermediate transfer-type apparatus that performs primary transfer by which the toner image (in the present exemplary embodiment, the black image and the magenta image) formed on the surface of the image holder is transferred to the surface of an intermediate transfer member and secondary transfer by which the toner image transferred to the surface of the intermediate transfer member is transferred to the surface of a recording medium; an apparatus including a cleaning unit that cleans the surface of the image holder before charging after the transfer of the toner image; and an apparatus including a charge neutralization unit that neutralizes charge by irradiating the surface of the image holder with charge neutralizing light before charging after the transfer of the toner image.

In the case of the intermediate transfer-type apparatus, as the transfer device, for example, a configuration is adopted that has an intermediate transfer member with surface on which the toner image will be transferred, a primary transfer device that performs primary transfer to transfer the toner image formed on the surface of the image holder to the surface of the intermediate transfer member, and a secondary transfer device that performs secondary transfer to transfer the toner image transferred to the surface of the intermediate transfer member to the surface of a recording medium.

In the image forming apparatus according to the present exemplary embodiment, for example, a portion including the developing device may be a cartridge structure (process cartridge) to be detachable from the image forming apparatus. As the process cartridge, for example, a process cartridge is suitably used that includes a developing device that contains each electrostatic charge image developer of the electrostatic charge image developer set according to the present exemplary embodiment.

Specifically, the process cartridge includes a first developing device containing the first electrostatic charge image developer in the electrostatic charge image developer set according to the present exemplary embodiment, and a second developing device containing the second electrostatic charge image developer in the electrostatic charge image developer set according to the present exemplary embodiment, in which the process cartridge is attachable to and detachable from an image forming apparatus.

An example of the image forming apparatus according to the present exemplary embodiment will be shown below, but the present invention is not limited thereto. Hereinafter, among the parts shown in the drawing, main parts will be described, and others will not be described.

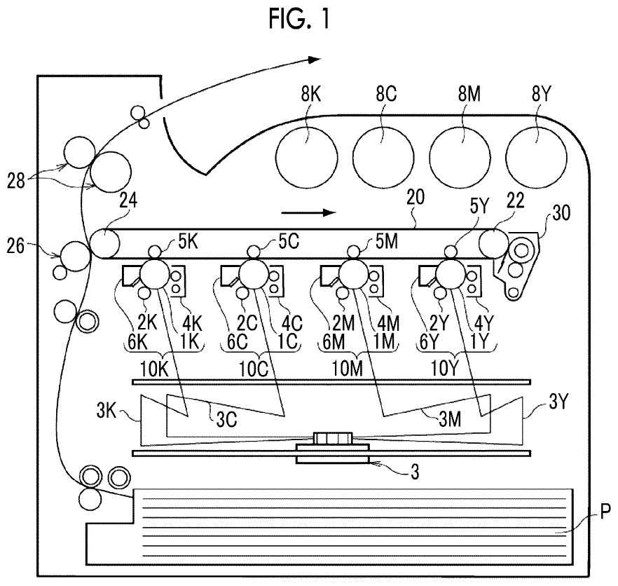

FIG. 1 is a view schematically showing the configuration of the image forming apparatus according to the present exemplary embodiment.

The image forming apparatus shown in FIG. 1 includes first to fourth image forming units 10Y, 10M, 10C, and 10K adopting an electrophotographic method that output images of colors, yellow (Y), magenta (M), cyan (C), and black (K), based on color-separated image data. These image forming units (hereinafter, simply referred to as “units” in some cases) 10Y, 10M, 10C, and 10K are arranged in a row in the horizontal direction in a state of being spaced apart by a predetermined distance. The units 10Y, 10M, 10C, and 10K may be process cartridges that are attached to and detached from the image forming apparatus.

An intermediate transfer belt 20 as an intermediate transfer member passing through the units 10Y, 10M, 10C, and 10K extends above the units in the drawing. The intermediate transfer belt 20 is looped over a driving roll 22 and a support roll 24 that in contact with the inner surface of the intermediate transfer belt 20, the rolls 22 and 24 being spaced apart in the horizontal direction in the drawing. The intermediate transfer belt 20 is designed to run in a direction toward the fourth unit 10K from the first unit 10Y. Force is applied to the support roll 24 in a direction away from the driving roll 22 by a spring or the like (not shown in the drawing). Tension is applied to the intermediate transfer belt 20 looped over the two rolls. An intermediate transfer member cleaning device 30 facing the driving roll 22 is provided on the outer peripheral surface of the intermediate transfer belt 20.

In addition, a toner including toners having four colors of yellow, magenta, cyan, and black, that are contained in containers of toner cartridges 8Y, 8M, 8C, and 8K, is supplied to developing devices (example of the developing device) 4Y, 4M, 4C, and 4K of the units 10Y, 10M, 10C, and 10K, respectively.

The first to fourth units 10Y, 10M, 10C, and 10K have the same configuration.

Therefore, in the present specification, as a representative, the first unit 10Y will be described that placed on the upstream side of the running direction of the intermediate transfer belt and forms a yellow image. Reference numerals marked with magenta (M), cyan (C), and black (K) instead of yellow (Y) are assigned in the same portions as in the first unit 10Y, such that the second to fourth units 10M, 10C, and 10K will not be described again.

The first unit 10Y has a photoreceptor 1Y that acts as an image holder. Around the photoreceptor 1Y, a charging roll (an example of the charging device) 2Y that charges the surface of the photoreceptor 1Y at a predetermined potential, an exposure device (an example of the electrostatic charge image forming device) 3 that exposes the charged surface to a laser beam 3Y based on color-separated image signals to form an electrostatic charge image, a developing device (an example of the developing device) 4Y that develops the electrostatic charge image by supplying a charged toner to the electrostatic charge image, a primary transfer roll (an example of the primary transfer device) 5Y that transfers the developed toner image onto the intermediate transfer belt 20, and a photoreceptor cleaning device (an example of the cleaning device) 6Y that removes the residual toner on the surface of the photoreceptor 1Y after the primary transfer are arranged in this order.

The primary transfer roll 5Y is disposed on the inner side of the intermediate transfer belt 20, at a position facing the photoreceptor 1Y. Furthermore, a bias power supply (not shown in the drawing) for applying a primary transfer bias is connected to each of primary transfer rolls 5Y, 5M, 5C, and 5K. Each bias power supply varies the transfer bias applied to each primary transfer roll under the control of a control unit not shown in the drawing.

Hereinafter, the operation that the first unit 10Y carries out to form a yellow image will be described.

First, prior to the operation, the surface of the photoreceptor 1Y is charged to a potential of −600 V to −800 V by the charging roll 2Y.

The photoreceptor 1Y is formed of a photosensitive layer laminated on a conductive (for example, volume resistivity at 20° C.: 1×10⁻⁶ Ω·cm or less) substrate. The photosensitive layer has properties in that although this layer usually has a high resistance (resistance of a general resin), in a case where the photosensitive layer is irradiated with the laser beam 3Y, the specific resistance of the portion irradiated with the laser beam changes. Therefore, via an exposure device 3, the laser beam 3Y is output to the surface of the charged photoreceptor 1Y according to the image data for yellow transmitted from the control unit not shown in the drawing. The laser beam 3Y is radiated to the photosensitive layer on the surface of the photoreceptor 1Y. As a result, an electrostatic charge image of a yellow image pattern is formed on the surface of the photoreceptor 1Y.

The electrostatic charge image is an image formed on the surface of the photoreceptor 1Y by charging. This image is a so-called negative latent image formed in a manner in which the charges with which the surface of the photoreceptor 1Y is charged flow due to the reduction in the specific resistance of the portion of the photosensitive layer irradiated with the laser beam 3Y, but the charges in a portion not being irradiated with the laser beam 3Y remain.

The electrostatic charge image formed on the photoreceptor 1Y rotates to a predetermined development position as the photoreceptor 1Y runs. At the development position, the electrostatic charge image on the photoreceptor 1Y turns into a visible image (developed image) as a toner image by the developing device 4Y.

The developing device 4Y contains, for example, an electrostatic charge image developer that contains at least a yellow toner and a carrier. By being stirred in the developing device 4Y, the yellow toner undergoes triboelectrification, carries charges of the same polarity (negative polarity) as the charges with which the surface of the photoreceptor 1Y is charged, and is held on a developer roll (an example of a developer holder). As the surface of the photoreceptor 1Y passes through the developing device 4Y, the yellow toner electrostatically adheres to the neutralized latent image portion on the surface of the photoreceptor 1Y, and the latent image is developed by the yellow toner. The photoreceptor 1Y on which the yellow toner image is formed keeps on running at a predetermined speed, and the toner image developed on the photoreceptor 1Y is transported to a predetermined primary transfer position.

In a case where the yellow toner image on the photoreceptor 1Y is transported to the primary transfer position, a primary transfer bias is applied to the primary transfer roll 5Y, and electrostatic force heading for the primary transfer roll 5Y from the photoreceptor 1Y acts on the toner image. As a result, the toner image on the photoreceptor 1Y is transferred onto the intermediate transfer belt 20. The transfer bias applied at this time has a polarity (+) opposite to the polarity (−) of the toner. For example, in the first unit 10Y, the transfer bias is set to +10 uA under the control of the control unit (not shown in the drawing).

On the other hand, the residual toner on the photoreceptor 1Y is removed by a photoreceptor cleaning device 6Y and collected.

In addition, the primary transfer bias applied to the primary transfer rolls 5M, 5C, and 5K following the second unit 10M is also controlled according to the first unit.

In this way, the intermediate transfer belt 20 to which the yellow toner image is transferred in the first unit 10Y is sequentially transported through the second to fourth units 10M, 10C, and 10K, and the toner images of each color are superimposed and transferred in layers.

The intermediate transfer belt 20, to which the toner images of four colors are transferred in layers through the first to fourth units, reaches a secondary transfer portion configured with the intermediate transfer belt 20, the support roll 24 in contact with the inner surface of the intermediate transfer belt, and a secondary transfer roll (an example of the secondary transfer device) 26 disposed on the outer peripheral surface side of the intermediate transfer belt 20. On the other hand, via a supply mechanism, recording paper P(an example of recording medium) is supplied at a predetermined timing to the gap between the secondary transfer roll 26 and the intermediate transfer belt 20 that are in contact with each other. Furthermore, secondary transfer bias is applied to the support roll 24. The transfer bias applied at this time has the same polarity (−) as the polarity (−) of the toner. The electrostatic force heading for the recording paper P from the intermediate transfer belt 20 acts on the toner image, that makes the toner image on the intermediate transfer belt 20 transferred onto the recording paper P. The secondary transfer bias to be applied at this time is determined according to the resistance detected by a resistance detecting device (not shown in the drawing) for detecting the resistance of the secondary transfer portion, and the voltage thereof is controlled.

Thereafter, the recording paper P is transported into a pressure contact portion (nip portion) of a pair of fixing rolls in the fixing device 28 (an example of the fixing device), the toner image is fixed to the surface of the recording paper P, and a fixed image is formed.

Examples of the recording paper P to which the toner image is to be transferred include plain paper used in electrophotographic copy machines, printers, and the like. Examples of the recording medium also include an OHP sheet, in addition to the recording paper P.

In order to further improve the smoothness of the image surface after fixing, for example, it is preferable that the surface of the recording paper P is also smooth. For example, coated paper prepared by coating the surface of plain paper with a resin or the like, art paper for printing, and the like are suitably used.

The recording paper P, on which the fixing of the color image has been completed, is transported to a discharge unit, and a series of color image forming operations is ended.

### Process Cartridge and Toner Cartridge

The process cartridge according to the present exemplary embodiment will be described.

The process cartridge according to the present exemplary embodiment includes a developing device that contains the electrostatic charge image developer according to the present exemplary embodiment and develops an electrostatic charge image formed on the surface of an image holder as a toner image by using the electrostatic charge image developer. The process cartridge is detachable from the image forming apparatus.

The process cartridge according to the present exemplary embodiment is not limited to the above configuration. The process cartridge may be configured with a developing device and, for example, at least one member selected from other devices, such as an image holder, a charging device, an electrostatic charge image forming device, and a transfer device, as necessary.

An example of the process cartridge according to the present exemplary embodiment will be shown below, but the present invention is not limited thereto. Hereinafter, among the parts shown in the drawing, main parts will be described, and others will not be described.

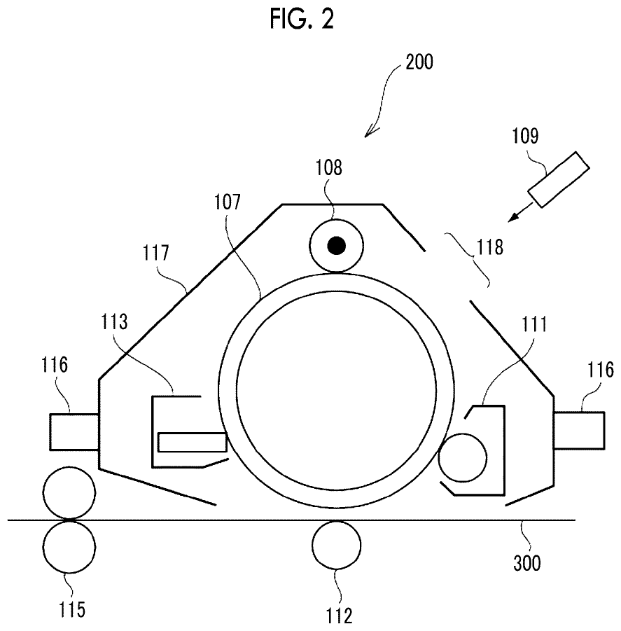

FIG. 2 is a view schematically showing the configuration of the process cartridge according to the present exemplary embodiment.

A process cartridge 200 shown in FIG. 2 is configured, for example, with a housing 117 that includes mounting rails 116 and an opening portion 118 for exposure, a photoreceptor 107 (an example of image holder), a charging roll 108 (an example of charging device) that is provided on the periphery of the photoreceptor 107, a developing device 111 (an example of developing device), a photoreceptor cleaning device 113 (an example of cleaning device), that are integrally combined and held in the housing 117. The process cartridge 200 forms a cartridge in this way.

In FIG. 2, 109 represents an exposure device (an example of electrostatic charge image forming device), 112 represents a transfer device (an example of transfer device), 115 represents a fixing device (an example of fixing device), and 300 represents recording paper (an example of recording medium).

Next, the toner cartridge according to the present exemplary embodiment will be described.

The toner cartridge according to the present exemplary embodiment is a toner cartridge including a container that contains each toner of the toner set according to the present exemplary embodiment and is detachable from the image forming apparatus. The toner cartridge includes a container that contains a replenishing toner to be supplied to the developing device provided in the image forming apparatus.

Specifically, the toner cartridge set according to the present exemplary embodiment is a toner cartridge set including a first toner cartridge that includes a container containing the black toner in the electrostatic charge image developing toner set according to the present exemplary embodiment, and a second toner cartridge that includes a container containing the magenta toner in the electrostatic charge image developing toner set according to the present exemplary embodiment, in which the toner cartridge set is attachable to and detachable from an image forming apparatus.

The image forming apparatus shown in FIG. 1 is an image forming apparatus having a configuration that enables toner cartridges 8Y, 8M, 8C, and 8K to be detachable from the apparatus. The developing devices 4Y, 4M, 4C, and 4K are connected to toner cartridges corresponding to the respective developing devices (colors) by a toner supply pipe not shown in the drawing. In addition, in a case where the amount of the toner contained in the container of the toner cartridge is low, the toner cartridge is replaced.

### EXAMPLES

Examples will be described below, but the present invention is not limited to these examples. In the following description, unless specified otherwise, “part(s)” and “%” represent “part(s) by mass” and “mass %”.

Preparation of Emulsion (1)
Styrene: 48.4 parts
n-Butyl acrylate: 50.1 parts
1,10-Decanediol diacrylate: 1.5 parts
Anionic surfactant (ELEMINOL MON-2, manufactured by Sanyo Chemical Industries, Ltd.): 1.2 parts
Deionized water: 98.8 parts

The above-described materials are charged into a mixing vessel equipped with a stirrer, and stirred to prepare an emulsion (1).

Preparation of Internally-added Crosslinked Resin Particle Dispersion (S1)

1.1 parts of an anionic surfactant (ELEMINOL MON-2) and 400 parts of deionized water are charged into a reaction vessel equipped with a stirrer and a nitrogen introduction tube, after replacing the inside of the reaction vessel with nitrogen. The reaction solution is heated in an oil bath while being stirred so that a temperature of the reaction solution is set to 75° C. After adding 10 parts of the emulsion (1) thereto, 20 parts of an ammonium persulfate aqueous solution in which a concentration is adjusted to 10% by mass is further added thereto, and the reaction solution is retained for 30 minutes.

Thereafter, in a state where the temperature of the reaction solution is maintained at 75° C., 190 parts of the emulsion (1) is gradually added dropwise to the reaction vessel over 30 minutes by a pump. 200 parts of the emulsion (1) is further added dropwise thereto over 30 minutes.

After completion of the dropwise addition, the solution is retained for 60 minutes, 2 parts of ammonium persulfate having a concentration of 10% by mass is added thereto, and the mixture is retained for another 3 hours and then cooled to room temperature. Thereafter, deionized water is added thereto so that the concentration of solid contents is 20% by mass, thereby obtaining an internally-added crosslinked resin particle dispersion (S1).

A volume-average particle size of the obtained resin particles is 165 nm. In addition, a glass transition temperature measured with a differential scanning calorimeter is 14.5° C.

### Preparation of Internally-added Crosslinked Resin Particle Dispersion (S2)

### Preparation of Emulsion (2)

An emulsion (2) is produced in the same manner as in the preparation of the emulsion (1), except that the amounts of styrene and n-butyl acrylate are changed to 39.0 parts and 59.5 parts. An internally-added crosslinked resin particle dispersion (S2) is produced in the same manner as in (S1), except that the emulsion (2) is used instead of the emulsion (1).

A volume-average particle size of the obtained resin particles is 169 nm. In addition, a glass transition temperature measured with a differential scanning calorimeter is −1° C.

### Preparation of Internally-added Crosslinked Resin Particle Dispersion (S3)

### Preparation of Emulsion (3)

An emulsion (3) is produced in the same manner as in the preparation of the emulsion (1), except that the amounts of styrene and n-butyl acrylate are changed to 57.6 parts and 40.9 parts. An internally-added crosslinked resin particle dispersion (S3) is produced in the same manner as in (S1), except that the emulsion (3) is used instead of the emulsion (1).

A volume-average particle size of the obtained resin particles is 166 nm. In addition, a glass transition temperature measured with a differential scanning calorimeter is 29.6° C.

### Preparation of Internally-added Crosslinked Resin Particle Dispersion (S4)

### Preparation of Emulsion (4)

An emulsion (4) is produced in the same manner as in the preparation of the emulsion (1), except that the amounts of styrene and n-butyl acrylate are changed to 39.7 parts and 58.8 parts. An internally-added crosslinked resin particle dispersion (S4) is produced in the same manner as in (S1), except that the emulsion (4) is used instead of the emulsion (1).

A volume-average particle size of the obtained resin particles is 163 nm. In addition, a glass transition temperature measured with a differential scanning calorimeter is 0.1° C.

### Preparation of Internally-added Crosslinked Resin Particle Dispersion (S5)

### Preparation of Emulsion (5)

An emulsion (5) is produced in the same manner as in the preparation of the emulsion (1), except that the amounts of styrene and n-butyl acrylate are changed to 58.6 parts and 39.9 parts. An internally-added crosslinked resin particle dispersion (S5) is produced in the same manner as in (S1), except that the emulsion (5) is used instead of the emulsion (1).

A volume-average particle size of the obtained resin particles is 168 nm. In addition, a glass transition temperature measured with a differential scanning calorimeter is 31.2° C.

### Preparation of Styrene-butadiene Rubber Particles (S6)·

Styrene: 54.0 parts
Butadiene: 44.5 parts
Acrylic acid: 1.4 parts
tert-Dodecanethiol: 0.1 parts
Anionic surfactant (Dowfax2a-1 manufactured by The Dow Chemical Company): 1.2 parts
Deionized water: 200 parts
Potassium persulfate: 1 part

The above-described materials are put into a polymerization reactor and polymerized in a nitrogen atmosphere and at a temperature of 50° C. for 2 hours, and then the reaction is continued for 3 hours to terminate the polymerization. Deionized water is added to the obtained dispersion, and the concentration of solid content is adjusted to 20% by mass to obtain a rubber particle dispersion (1).

A volume-average particle size of the obtained rubber particles is 200 nm. In addition, a glass transition temperature measured with a differential scanning calorimeter is 14.9° C. Preparation of Amorphous Polyester Resin Particle Dispersion (KA1)

| | |
|---|---|
| Terephthalic acid: | 80 parts by mole |
| Fumaric acid: | 13 parts by mole |
| Isophthalic acid: | 5 parts by mole |
| Trimellitic anhydride: | 2 parts by mole |
| Propylene oxide (2 mol) adduct of bisphenol A: | 20 parts by mole |
| Propylene oxide (3 mol) adduct of bisphenol A: | 80 parts by mole |

The above-described materials are charged into a reaction vessel equipped with a stirrer, a nitrogen introduction tube, a temperature sensor, and a rectifying column, the temperature is raised to 190° C. over 1 hour, and dibutyltin oxide is added thereto in an amount of 1.2 parts with respect to 100 parts of the materials. While the generated water is distilled off, the temperature is raised to 240° C. over 6 hours, and a dehydrocondensation reaction is continued for 3 hours in the reaction solution retained at 240° C. to obtain an amorphous polyester resin (KA1).

| | |
|---|---|
| Amorphous polyester resin (KA1): | 100 parts |
| Methyl ethyl ketone: | 55 parts |
| Isopropanol: | 10 parts |
| 10% Aqueous ammonia solution: | 3.3 parts |

The above-described materials are put in a jacketed reaction tank equipped with a condenser, a thermometer, a water dripping device, and an anchor blade, and in a state in which the reaction tank is retained at a liquid temperature of 50° C. in a water-circulation type thermostatic bath, the amorphous polyester resin (KA1) is dissolved while stirring and mixing the mixture at 100 rpm. Next, the water-circulation type thermostatic bath is set to 40° C., and a total of 300 parts of deionized water retained at 40° C. is added dropwise to the reaction tank at a rate of 3 parts/min to cause phase inversion, thereby obtaining an emulsion.

The obtained emulsion is added to an eggplant flask, and the eggplant flask is set through a trap ball in an evaporator equipped with a vacuum control unit. While being rotated, the eggplant flask is heated in a hot water bath at 60° C., the pressure is reduced to 7 kPa with care to sudden boiling to remove the solvent, and then returned to normal pressure, and the eggplant flask is water-cooled to obtain a dispersion. Deionized water is added to the obtained dispersion, thereby obtaining an amorphous polyester resin particle dispersion (KA1) having a solid content of 20% by mass. A volume-average particle size of the amorphous polyester resin particles in the amorphous polyester resin particle dispersion (KA1) is 150 nm.

### Preparation of Amorphous Polyester Resin Particle Dispersion (KA2)

| | |
|---|---|
| Terephthalic acid: | 85 parts by mole |
| Fumaric acid: | 13 parts by mole |
| Trimellitic anhydride: | 2 parts by mole |

A resin particle dispersion in which resin particles having a volume-average particle size of 152 nm are dispersed is obtained in the same manner as in the amorphous polyester resin particle dispersion (KA1), except that the above-described materials are used as an acid component. Deionized water is added to the resin particle dispersion to adjust the solid content to 20% by mass, thereby obtaining an amorphous polyester resin particle dispersion (KA2). Preparation of Amorphous Polyester Resin Particle Dispersion (KA3)

| | |
|---|---|
| Terephthalic acid: | 75 parts by mole |
| Fumaric acid: | 13 parts by mole |
| Isophthalic acid: | 10 parts by mole |
| Trimellitic anhydride: | 2 parts by mole |

A resin particle dispersion in which resin particles having a volume-average particle size of 151 nm are dispersed is obtained in the same manner as in the amorphous polyester resin particle dispersion (KA1), except that the above-described materials are used as an acid component. Deionized water is added to the resin particle dispersion to adjust the solid content to 20% by mass, thereby obtaining an amorphous polyester resin particle dispersion (KA3).

### Preparation of Amorphous Polyester Resin Particle Dispersion (KA4)

| | |
|---|---|
| Terephthalic acid: | 65 parts by mole |
| Fumaric acid: | 13 parts by mole |
| Isophthalic acid: | 20 parts by mole |
| Trimellitic anhydride: | 2 parts by mole |

A resin particle dispersion in which resin particles having a volume-average particle size of 155 nm are dispersed is obtained in the same manner as in the amorphous polyester resin particle dispersion (KA1), except that the above-described materials are used as an acid component. Deionized water is added to the resin particle dispersion to adjust the solid content to 20% by mass, thereby obtaining an amorphous polyester resin particle dispersion (KA4). Preparation of Amorphous Polyester Resin Particle Dispersion (KA5)

| | |
|---|---|
| Terephthalic acid: | 53.5 parts by mole |
| Isophthalic acid: | 46.5 parts by mole |

A resin particle dispersion in which resin particles having a volume-average particle size of 151 nm are dispersed is obtained in the same manner as in the amorphous polyester resin particle dispersion (KA1), except that the above-described materials are used as an acid component. Deionized water is added to the resin particle dispersion to adjust the solid content to 20% by mass, thereby obtaining an amorphous polyester resin particle dispersion (KA5).

### Preparation of Amorphous Polyester Resin Particle Dispersion (KA6)

| | |
|---|---|
| Terephthalic acid: | 32 parts by mole |
| Fumaric acid: | 13 parts by mole |
| Isophthalic acid: | 33 parts by mole |
| Trimellitic anhydride: | 22 parts by mole |

A resin particle dispersion in which resin particles having a volume-average particle size of 158 nm are dispersed is obtained in the same manner as in the amorphous polyester resin particle dispersion (KA1), except that the above-described materials are used as an acid component. Deionized water is added to the resin particle dispersion to adjust the solid content to 20% by mass, thereby obtaining an amorphous polyester resin particle dispersion (KA6). Preparation of Amorphous Polyester Resin Particle Dispersion (MA1)

| | |
|---|---|
| Terephthalic acid: | 55 parts by mole |
| Isophthalic acid: | 30 parts by mole |
| Trimellitic anhydride: | 15 parts by mole |

A resin particle dispersion in which resin particles having a volume-average particle size of 155 nm are dispersed is obtained in the same manner as in the preparation of the amorphous polyester resin particle dispersion (KA1), except that the above-described materials are used as an acid component. Deionized water is added to the resin particle dispersion to adjust the solid content to 20% by mass, thereby obtaining an amorphous polyester resin particle dispersion (MA1).

### Preparation of Amorphous Polyester Resin Particle Dispersion (MA2)

| | |
|---|---|
| Terephthalic acid: | 45 parts by mole |
| Isophthalic acid: | 40 parts by mole |
| Trimellitic anhydride: | 15 parts by mole |

A resin particle dispersion in which resin particles having a volume-average particle size of 150 nm are dispersed is obtained in the same manner as in the amorphous polyester resin particle dispersion (KA1), except that the above-described materials are used as an acid component. Deionized water is added to the resin particle dispersion to adjust the solid content to 20% by mass, thereby obtaining an amorphous polyester resin particle dispersion (MA2). Preparation of Amorphous Polyester Resin Particle Dispersion (MA3)

| | |
|---|---|
| Terephthalic acid: | 65 parts by mole |
| Isophthalic acid: | 20 parts by mole |
| Trimellitic anhydride: | 15 parts by mole |

A resin particle dispersion in which resin particles having a volume-average particle size of 153 nm are dispersed is obtained in the same manner as in the amorphous polyester resin particle dispersion (KA1), except that the above-described materials are used as an acid component. Deionized water is added to the resin particle dispersion to adjust the solid content to 20% by mass, thereby obtaining an amorphous polyester resin particle dispersion (MA3). Preparation of Amorphous Polyester Resin Particle Dispersion (MA4)

| | |
|---|---|
| Terephthalic acid: | 75 parts by mole |
| Isophthalic acid: | 10 parts by mole |
| Trimellitic anhydride: | 15 parts by mole |

A resin particle dispersion in which resin particles having a volume-average particle size of 152 nm are dispersed is obtained in the same manner as in the amorphous polyester resin particle dispersion (KA1), except that the above-described materials are used as an acid component. Deionized water is added to the resin particle dispersion to adjust the solid content to 20% by mass, thereby obtaining an amorphous polyester resin particle dispersion (MA4). Preparation of Amorphous Polyester Resin Particle Dispersion (MA5)

| | |
|---|---|
| Terephthalic acid: | 74 parts by mole |
| Isophthalic acid: | 11 parts by mole |
| Trimellitic anhydride: | 15 parts by mole |

A resin particle dispersion in which resin particles having a volume-average particle size of 158 nm are dispersed is obtained in the same manner as in the amorphous polyester resin particle dispersion (KA1), except that the above-described materials are used as an acid component. Deionized water is added to the resin particle dispersion to adjust the solid content to 20% by mass, thereby obtaining an amorphous polyester resin particle dispersion (MA5). Preparation of Amorphous Polyester Resin Particle Dispersion (MA6)

| | |
|---|---|
| Terephthalic acid: | 70 parts by mole |
| Isophthalic acid: | 15 parts by mole |
| Trimellitic anhydride: | 15 parts by mole |

A resin particle dispersion in which resin particles having a volume-average particle size of 152 nm are dispersed is obtained in the same manner as in the amorphous polyester resin particle dispersion (KA1), except that the above-described materials are used as an acid component. Deionized water is added to the resin particle dispersion to adjust the solid content to 20% by mass, thereby obtaining an amorphous polyester resin particle dispersion (MA6). Preparation of Amorphous Polyester Resin Particle Dispersion (MA7)

| | |
|---|---|
| Terephthalic acid: | 35 parts by mole |
| Isophthalic acid: | 50 parts by mole |
| Trimellitic anhydride: | 15 parts by mole |

A resin particle dispersion in which resin particles having a volume-average particle size of 154 nm are dispersed is obtained in the same manner as in the amorphous polyester resin particle dispersion (KA1), except that the above-described materials are used as an acid component. Deionized water is added to the resin particle dispersion to adjust the solid content to 20% by mass, thereby obtaining an amorphous polyester resin particle dispersion (MA7). Preparation of Amorphous Polyester Resin Particle Dispersion (MA8)

| | |
|---|---|
| Terephthalic acid: | 5 parts by mole |
| Isophthalic acid: | 80 parts by mole |
| Trimellitic anhydride: | 15 parts by mole |

A resin particle dispersion in which resin particles having a volume-average particle size of 153 nm are dispersed is obtained in the same manner as in the amorphous polyester resin particle dispersion (KA1), except that the above-described materials are used as an acid component. Deionized water is added to the resin particle dispersion to adjust the solid content to 20% by mass, thereby obtaining an amorphous polyester resin particle dispersion (MA8). Preparation of Amorphous Polyester Resin Particle Dispersion (MA9)

| | |
|---|---|
| Terephthalic acid: | 4 parts by mole |
| Isophthalic acid: | 81 parts by mole |
| Trimellitic anhydride: | 15 parts by mole |

A resin particle dispersion in which resin particles having a volume-average particle size of 155 nm are dispersed is obtained in the same manner as in the amorphous polyester resin particle dispersion (KA1), except that the above-described materials are used as an acid component. Deionized water is added to the resin particle dispersion to adjust the solid content to 20% by mass, thereby obtaining an amorphous polyester resin particle dispersion (MA9). Preparation of Amorphous Polyester Resin Particle Dispersion (MA10)

| | |
|---|---|
| Terephthalic acid: | 15 parts by mole |
| Isophthalic acid: | 70 parts by mole |
| Trimellitic anhydride: | 15 parts by mole |

A resin particle dispersion in which resin particles having a volume-average particle size of 157 nm are dispersed is obtained in the same manner as in the amorphous polyester resin particle dispersion (KA1), except that the above-described materials are used as an acid component. Deionized water is added to the resin particle dispersion to adjust the solid content to 20% by mass, thereby obtaining an amorphous polyester resin particle dispersion (MA10). Preparation of Amorphous Polyester Resin Particle Dispersion (MA11)

| | |
|---|---|
| Terephthalic acid: | 71 parts by mole |
| Isophthalic acid: | 14 parts by mole |
| Trimellitic anhydride: | 15 parts by mole |

A resin particle dispersion in which resin particles having a volume-average particle size of 152 nm are dispersed is obtained in the same manner as in the amorphous polyester resin particle dispersion (KA1), except that the above-described materials are used as an acid component. Deionized water is added to the resin particle dispersion to adjust the solid content to 20% by mass, thereby obtaining an amorphous polyester resin particle dispersion (MA11). Preparation of Amorphous Polyester Resin Particle Dispersion (MA12)

| | |
|---|---|
| Terephthalic acid: | 39 parts by mole |
| Isophthalic acid: | 46 parts by mole |
| Trimellitic anhydride: | 15 parts by mole |

A resin particle dispersion in which resin particles having a volume-average particle size of 150 nm are dispersed is obtained in the same manner as in the amorphous polyester resin particle dispersion (KA1), except that the above-described materials are used as an acid component. Deionized water is added to the resin particle dispersion to adjust the solid content to 20% by mass, thereby obtaining an amorphous polyester resin particle dispersion (MA12). Preparation of Crystalline Polyester Resin Particle Dispersion (C1)

| | |
|---|---|
| 1,10-Dodecanedioic acid: | 225 parts |
| 1,6-Hexanediol: | 174 parts |

The above-described materials are charged into a reaction vessel equipped with a stirrer, a nitrogen introduction tube, a temperature sensor, and a rectifying column, the temperature is raised to 160° C. over 1 hour, and 0.8 parts by mass of dibutyltin oxide is added thereto. While the generated water is distilled off, the temperature is raised to 180° C. over 6 hours, and the mixture is stirred for 5 hours in a state of being kept at 180° C. and refluxed such that the reaction proceeds. Thereafter, the temperature is slowly raised to 230° C. under reduced pressure (3 kPa), and the reaction solution is stirred for 2 hours in a state of being kept at 230° C. Thereafter, the reaction product is cooled. After the cooling, solid-liquid separation is performed, and the solids are dried, thereby obtaining a crystalline polyester resin (C1). A melting point of the obtained polyester resin (C1) is 71° C.

| | |
|---|---|
| Crystalline polyester resin (C1): | 100 parts |
| Methyl ethyl ketone: | 40 parts |
| Isopropanol: | 30 parts |
| 10% Aqueous ammonia solution: | 4 parts |

The above-described materials are put in a 3 L jacketed reaction tank (manufactured by EYELA: BJ-30N) equipped with a condenser, a thermometer, a water dripping device, and an anchor blade. In a state where the reaction tank is kept at 80° C. in a water-circulation type thermostatic bath, and the materials are stirred and mixed together at 100 rpm, the resin is dissolved. Thereafter, the water-circulation type thermostatic bath is set to 50° C., and a total of 400 parts of deionized water retained at 50° C. is added dropwise to the reaction tank at a rate of 10 parts by mass/min to cause phase inversion, thereby obtaining an emulsion. 576 parts by mass of the obtained emulsion and 500 parts by mass of deionized water are put in a 2 L eggplant flask and set in an evaporator (manufactured by EYELA) equipped with a vacuum controlled unit through a trap ball. While being rotated, the eggplant flask is heated in a hot water bath at 60° C., and the pressure is reduced to 7 kPa with care to sudden boiling, thereby removing the solvent. At a point in time when the amount of solvent collected reaches 750 parts by mass, the pressure is returned to normal pressure, and the eggplant flask is cooled in water, thereby obtaining a dispersion. A volume-average particle size D50v of the resin particles in the dispersion is 110 nm. Thereafter, deionized water is added thereto to obtain a crystalline polyester resin particle dispersion (C1) having a concentration of solid contents of 20% by mass.

### Preparation of Crystalline Polyester Resin Particle Dispersion (C2)

| | |
|---|---|
| Suberic acid: | 225 parts |
| 1,6-Hexanediol: | 174 parts |

A crystalline polyester resin (C2) is obtained in the same manner as in the crystalline polyester resin particle dispersion (C1), except that the above-described materials are used. A melting point thereof is 70° C.

### Preparation of Crystalline Polyester Resin Particle Dispersion (C3)

| | |
|---|---|
| Tetradecanedioic acid: | 225 parts |
| 1,10-Decanediol: | 174 parts |

A crystalline polyester resin (C3) is obtained in the same manner as in the crystalline polyester resin particle dispersion (C1), except that the above-described materials are used. A melting point thereof is 72° C.

### Preparation of Crystalline Polyester Resin Particle Dispersion (C4)

| | |
|---|---|
| Suberic acid: | 225 parts |
| 1,6-Hexanediol: | 174 parts |

A crystalline polyester resin (C4) is obtained in the same manner as in the crystalline polyester resin particle dispersion (C1), except that the above-described materials are used, and the mixture is stirred at 180° C. for 8 hours. A melting point thereof is 73° C.

### Preparation of Crystalline Polyester Resin Particle Dispersion (C5)

| | |
|---|---|
| Tetradecanedioic acid: | 225 parts |
| 1,10-Decanediol: | 174 parts |

A crystalline polyester resin (C5) is obtained in the same manner as in the crystalline polyester resin particle dispersion (C1), except that the above-described materials are used, and the mixture is stirred at 180° C. for 8 hours. A melting point thereof is 73° C.

### Preparation of Colorant Dispersion (K1)

| | |
|---|---|
| Carbon black (Regel 330, manufactured by Cabot | 110 parts |
| Corporation.): | |
| Anionic surfactant (NEOPELEX G-65, Kao Corporation): | 6 parts |
| Deionized water: | 300 parts |

The above-described materials are mixed together and dispersed for 10 minutes using a homogenizer (ULTRA-TURRAX T50, manufactured by IKA). Deionized water is added to the obtained dispersion, thereby obtaining a colorant dispersion (K1) having a solid content of 20% by mass. A volume-average particle size of the colorant particles in the colorant dispersion (K1) is 220 nm.

### Preparation of Colorant Dispersion (M1)

| | |
|---|---|
| Magenta colorant (“C.I. Pigment Red 122”, | 110 parts |
| manufactured by Zeya Chemicals): | |
| Anionic surfactant (NEOPELEX G-65, Kao | 6 parts |
| Corporation): | |
| Deionized water: | 300 parts |

The above-described materials are mixed together and dispersed for 10 minutes using a homogenizer (ULTRA-TURRAX T50, manufactured by IKA). Deionized water is added to the obtained dispersion, thereby obtaining a colorant dispersion (M1) having a solid content of 20% by mass. A volume-average particle size of the colorant particles in the colorant dispersion (M1) is 220 nm.

### Preparation of Release Agent Particle Dispersion

| | |
|---|---|
| Fischer-Tropsch wax (Sasol wax H1, SASOL): | 100 parts |
| Anionic surfactant (NEOPELEX G-65): | 6 parts |
| Deionized water: | 300 parts |

The above-described materials are mixed together, heated to 100° C., and dispersed using a homogenizer (ULTRA-TURRAX T50). Furthermore, a dispersion treatment is performed using a Manton Gaulin high-pressure homogenizer (manufactured by Gaulin Corporation), and deionized water is added to the dispersion, thereby obtaining a release agent particle dispersion having a solid content of 20% by mass.

A volume-average particle size of the release agent particles in the release agent particle dispersion is 230 nm.

### Preparation of Black Toner (K1)

| | |
|---|---|
| Amorphous polyester resin particle dispersion | 68.4 parts |
| (KA1) (solid content: 20% by mass): | |
| Internally-added crosslinked resin particle | 20 parts |
| dispersion (1) (solid content: 20% by mass): | |
| Crystalline polyester resin particle dispersion | 29.6 parts |
| (C1) (solid content: 20% by mass): | |
| Colorant dispersion (K1) (solid content: 20% | 21 parts |
| by mass): | |
| Release agent particle dispersion (solid | 11 parts |
| content: 20% by mass): | |
| Anionic surfactant (ELEMINOL MON-2): | 0.7 parts |
| Deionized water: | 200 parts |

The above-described materials are put in a reaction vessel equipped with a thermometer, a pH meter, and a stirrer, and the temperature of the reaction vessel is kept at 20° C. and retained for 30 minutes while stirring at a rotation speed of 150 rpm. Next, a 0.3N nitric acid aqueous solution is added thereto such that the pH is adjusted to 5.0, and then a 2% aluminum sulfate aqueous solution is added thereto in a state in which the reaction solution is dispersed with a homogenizer (ULTRA-TURRAX T50). Next, in a state in which the reaction solution is stirred, the temperature thereof is raised to 45° C. at a rate of 0.4° C./min and retained for 30 minutes.

Next, 50 parts of the amorphous polyester resin particle dispersion (KA1) is added thereto, and the mixture is retained for 30 minutes. Next, a 0.1 N sodium hydroxide aqueous solution is added thereto such that the pH is adjusted to 8.5, and the reaction solution is retained for 15 minutes, heated to 80° C. at a rate of 1° C./min while being continuously stirred, and retained at 80° C. for 5 hours. Next, after cooling, solid-liquid separation, and washing of solid matter with deionized water, the solid matter is dried for 24 hours in a freeze vacuum dryer to obtain toner particles (K1) having a volume-average particle size of 5.5 μm.

100 parts of the toner particles (K1) and 2.0 parts of hydrophobic silica (manufactured by Nippon Aerosil Co., Ltd.; product name: RY200) are mixed with a Henshell mixer to obtain a black toner (K1).

### Preparation of Black Toners (K2) to (K22)

Black toners (K2) to (K22) are obtained in the same manner as in the production of the black toner (K1), except that the type and the amount of each resin particle dispersion added are changed as shown in Table 4.

The additional added amorphous polyester resin particle dispersion is also changed to the amorphous polyester resin particle dispersion shown in Table 4. However, the amount of the additional added amorphous polyester resin particle dispersion is set to 50 parts, which is the same as in the black toner (K1).

### Preparation of Magenta Toner (M1)

| | |
|---|---|
| Amorphous polyester resin particle dispersion | 76.4 parts |
| (MA1) (solid content: 20% by mass): | |
| Internally-added crosslinked resin particle | 10 parts |
| dispersion (1) (solid content: 20% by mass): | |
| Crystalline polyester resin particle dispersion | 31.6 parts |
| (C1) (solid content: 20% by mass): | |
| Colorant dispersion (M1) (solid content: 20% | 21 parts |
| by mass): | |
| Release agent particle dispersion (solid | 11 parts |
| content: 20% by mass): | |
| Anionic surfactant (ELEMINOL MON-2): | 0.7 parts |
| Deionized water: | 200 parts |

The above-described materials are put in a reaction vessel equipped with a thermometer, a pH meter, and a stirrer, and the temperature of the reaction vessel is kept at 20° C. and retained for 30 minutes while stirring at a rotation speed of 150 rpm. Next, a 0.3N aqueous nitric acid solution is added thereto such that the pH is adjusted to 5.0, and then a 2% aluminum sulfate aqueous solution is added thereto in a state in which the reaction solution is dispersed with a homogenizer (ULTRA-TURRAX T50). Next, in a state in which the reaction solution is stirred, the temperature thereof is raised to 45° C. at a rate of 0.4° C./min and retained for 30 minutes.

Next, 50 parts of the amorphous polyester resin particle dispersion (MA1) is added thereto, and the mixture is retained for 30 minutes. Next, a 0.1 N sodium hydroxide aqueous solution is added thereto such that the pH is adjusted to 8.5, and the reaction solution is retained for 15 minutes, heated to 80° C. at a rate of 1° C./min while being continuously stirred, and retained at 80° C. for 5 hours. Next, after cooling, solid-liquid separation, and washing of solid matter with deionized water, the solid matter is dried for 24 hours in a freeze vacuum dryer to obtain toner particles (M1) having a volume-average particle size of 5.5 μm.

100 parts of the toner particles (M1) and 2.0 parts of hydrophobic silica (manufactured by Nippon Aerosil Co., Ltd.; product name: RY200) are mixed with a Henshell mixer to obtain a magenta toner (M1).

### Production of Magenta Toners (M2) to (M32)

Magenta toners (M2) to (M32) are obtained in the same manner as in the production of the magenta toner (M1), except that the type and the amount of each resin particle dispersion added are changed as shown in Table 4.

The additional added amorphous polyester resin particle dispersion is also changed to the amorphous polyester resin particle dispersion shown in Table 4. However, the amount of the additional added amorphous polyester resin particle dispersion is set to 50 parts, which is the same as in the magenta toner (M1).

### Examples 1 to 44 and Comparative Examples 1 to 6

The combination of the black toner and the magenta toner shown in Table 5 is used as a toner set of each example.

The following items of each toner are shown. The methods for measuring the characteristics of the toner are as described above.
Content (% by mass) WC(K) of the crystalline polyester resin with respect to the binder resin in the black toner particles
Content (% by mass) WC(M) of the crystalline polyester resin with respect to the binder resin in the magenta toner particles
Mass proportion (% by mass) P(K) of the constitutional unit derived from a phthalic acid other than terephthalic acid with respect to the constitutional unit derived from a polyvalent carboxylic acid in the amorphous polyester resin contained in the black toner particles
Mass proportion (% by mass) P(M) of the constitutional unit derived from a phthalic acid other than terephthalic acid with respect to the constitutional unit derived from a polyvalent carboxylic acid in the amorphous polyester resin contained in the magenta toner particles
Mass proportion (% by mass) PT (K) of the constitutional unit derived from terephthalic acid with respect to the constitutional unit derived from a polyvalent carboxylic acid in the amorphous polyester resin contained in the black toner particles
Mass proportion (% by mass) PT (M) of the constitutional unit derived from terephthalic acid with respect to the constitutional unit derived from a polyvalent carboxylic acid in the amorphous polyester resin contained in the magenta toner particles
Component type, glass transition temperature (Tg), and amount WT(K) (% by mass) of tetrahydrofuran-insoluble component in the black toner particles
Component type, glass transition temperature (Tg), and amount WT(M) (% by mass) of tetrahydrofuran-insoluble component in the magenta toner particles
Maximal peak temperature obtained at second temperature rise in the thermal analysis measurement of the black toner and the magenta toner by differential scanning calorimetry (DSC) (in the table, described as maximal peak temperature of DSC curve)

### Evaluation

### Production of Developer

8 parts of each toner in the toner set of each example and 92 parts of a carrier described below are mixed to prepare each developer, thereby obtaining a developer set of a black developer and a magenta developer. The obtained developer set is used for evaluations described below.

### Production of Carrier

| | |
|---|---|
| Ferrite particles (average particle size: | 100 parts |
| 35 μm): | |
| Toluene: | 14 parts |
| Styrene/methyl methacrylate copolymer | 3 parts |
| (copolymerization ratio: 15/85): | |
| Carbon black: | 0.2 parts |

The above-described components excluding the ferrite particles are dispersed with a sand mill, thereby preparing a dispersion. The dispersion is put in a vacuum deaerating kneader together with the ferrite particles, and dried under reduced pressure while being stirred, thereby obtaining a carrier.

### Low-temperature Fixability

The black toner and the magenta toner of each of the produced developer sets are respectively filled in a black developer container and a magenta developer container of a modified machine of “Revoria Press PC1120” manufactured by FUJIFILM Business Innovation Corp. as an image quality evaluation device.

Using the image quality evaluation device, a black solid image and a magenta solid image are formed on Colotech 90 paper (manufactured by Xerox Co., Ltd.) with the black toner and the magenta toner, respectively.

Whether or not a cold offset (phenomenon in which the fixing image is transferred to the fixing member due to insufficient heating of the toner) occurred in the obtained fixing image is visually confirmed, and evaluated according to the following evaluation standard.
A: no transfer trace
B: slight transfer trace
C: transfer is observed.

### Non-uniformity of Glossiness in Image

The black toner and the magenta toner of each of the produced developer sets are respectively filled in a black developer container and a magenta developer container of a modified machine of “Revoria Press PC1120” manufactured by FUJIFILM Business Innovation Corp. as an image quality evaluation device.

Using the image quality evaluation device, a black solid image and a magenta solid image are formed on coated paper (OK topcoat, manufactured by Oji Paper Co., Ltd.) with the black toner and the magenta toner, respectively.

Thereafter, each of the obtained images is left under direct sunlight for 1 month.

After the standing, the glossiness of the black solid image and the magenta solid image are measured using a gloss meter GM-26D (manufactured by Murakami Color Research Laboratory Co., Ltd.) under the condition of an incidence light angle of 75 degrees to the image. The glossiness is measured by selecting five points at random on each solid image, and an average value thereof is calculated.

Next, a difference between the average values of the glossiness of the black solid image and the magenta solid image is obtained, and evaluated according to the following evaluation standard.

In addition, a difference between average values of the glossiness of the black solid image and the magenta solid image is obtained in the same manner as described above, except that each of the obtained images is left to stand in a dark room in an environment of 55° C. for 2 weeks, instead of the direct sunlight, and the evaluation is performed according to the following evaluation standard.

As the difference in glossiness is smaller, the non-uniformity of glossiness between the black solid image and the magenta solid image (that is, glossiness unevenness) is smaller. It is noted that the difference in glossiness of 5.0 or more is not allowed.
G0: difference in glossiness is 0 or more and 1.0 or less.
G1: difference in glossiness is 1.1 or more and 2.0 or less.
G2: difference in glossiness is 2.1 or more and 3.5 or less.
G3: difference in glossiness is 3.6 or more and 4.9 or less.
G4: difference in glossiness is 5.0 or more (NG).

TABLE 1

| Internally-added | | | | | 1,10- | | | |
|---|---|---|---|---|---|---|---|---|
| crosslinked resin | | | n-Butyl | | Decanediol | Acrylic | tert- | |
| particle dispersion | Emulsion | Styrene | acrylate | Butadiene | diacrylate | acid | Dodecanethiol | Tg |
| Type | Type | Part | Part | Part | Part | Part | Part | ° C. |
| S1 | (1) | 48.4 | 50.1 | | 1.5 | | | 14.5 |
| S2 | (2) | 39.0 | 59.5 | | 1.5 | | | −1 |
| S3 | (3) | 57.6 | 40.9 | | 1.5 | | | 29.6 |
| S4 | (4) | 39.7 | 58.8 | | 1.5 | | | 0.1 |
| S5 | (5) | 58.6 | 39.9 | | 1.5 | | | 31.2 |
| S6 | | 54.0 | | 44.5 | | 1.4 | 0.1 | 14.9 |
| (styrene-butadiene | | | | | | | | |
| rubber particles) | | | | | | | | |

TABLE 2

| | Type and amount of polyvalent carboxylic acid | | | |
|---|---|---|---|---|
| Amorphous PES | Terephthalic | Fumaric | Isophthalic | Trimellitic |
| resin particle | acid | acid | acid | anhydride |
| dispersion | Part by | Part by | Part by | Part by |
| Type | mole | mole | mole | mole |

Amorphous polyester resin particle dispersion for black toner

| | | | | |
|---|---|---|---|---|
| KA1 | 80 | 13 | 5 | 2 |
| KA2 | 85 | 13 | 0 | 2 |
| KA3 | 75 | 13 | 10 | 2 |
| KA4 | 65 | 13 | 20 | 2 |
| KA5 | 53.5 | 0 | 46.5 | 0 |
| KA6 | 32 | 13 | 33 | 22 |

Amorphous polyester resin particle dispersion for magenta toner

| | | | | |
|---|---|---|---|---|
| MA1 | 55 | 0 | 30 | 15 |
| MA2 | 45 | 0 | 40 | 15 |
| MA3 | 65 | 0 | 20 | 15 |
| MA4 | 75 | 0 | 10 | 15 |
| MA5 | 74 | 0 | 11 | 15 |
| MA6 | 70 | 0 | 15 | 15 |
| MA7 | 35 | 0 | 50 | 15 |
| MA8 | 5 | 0 | 80 | 15 |
| MA9 | 4 | 0 | 81 | 15 |
| MA10 | 15 | 0 | 70 | 15 |
| MA11 | 71 | 0 | 14 | 15 |
| MA12 | 39 | 0 | 46 | 15 |

TABLE 3

| Crystalline PES resin | Polyvalent carboxylic | |
|---|---|---|
| particle dispersion | acid | Polyhydric alcohol |
| C1 | 1,10-Dodecanedioic | 1,6-Hexanediol |
| | acid | |
| C2 | Suberic acid | 1,6-Hexanediol |
| C3 | Tetradecanedioic acid | 1,10-Decanediol |
| C4 | Suberic acid | 1,6-Hexanediol |
| C5 | Tetradecanedioic acid | 1,10-Decanediol |

TABLE 4

| | Black toner production conditions | | | | | | | | Magenta toner production conditions | | | | | | |
|---|---|---|---|---|---|---|---|---|---|---|---|---|---|---|---|
| | Amorphous | | | Crystalline | | Internally-added | | | Amorphous | | | Crystalline | | Internally-added | |
| | PES resin | | | PES resin | | crosslinked resin | | | PES resin | | | PES resin | | crosslinked resin | |
| | particle | | | particle | | particle | | | particle | | | particle | | particle | |
| | dispersion | | | dispersion | | dispersion | | | dispersion | | | dispersion | | dispersion | |
| | | Charged | Addition | | Charged | | Charged | | | Charged | Addition | | Charged | | Charged |
| | | amount | amount | | amount | | amount | | | amount | amount | | amount | | amount |
| | Type | (part) | (part) | Type | (part) | Type | (part) | | Type | (part) | (part) | Type | (part) | Type | (part) |
| Black | KA1 | 68.4 | 50 | C1 | 29.6 | S1 | 20.0 | M | MA1 | 76.4 | 50 | C1 | 31.6 | S1 | 10.0 |
| toner | | | | | | | | toner | | | | | | | |
| K1 | | | | | | | | M1 | | | | | | | |
| Black | KA1 | 38.9 | 50 | C1 | 59.1 | S1 | 20.0 | M | MA1 | 44.7 | 50 | C1 | 63.3 | S1 | 10.0 |
| toner | | | | | | | | toner | | | | | | | |
| K2 | | | | | | | | M2 | | | | | | | |
| Black | KA1 | 87.7 | 50 | C1 | 10.3 | S1 | 20.0 | M | MA1 | 96.9 | 50 | C1 | 11.1 | S1 | 10.0 |
| toner | | | | | | | | toner | | | | | | | |
| K3 | | | | | | | | M3 | | | | | | | |
| Black | KA2 | 68.4 | 50 | C1 | 29.6 | S1 | 20.0 | M | MA2 | 76.4 | 50 | C1 | 31.6 | S1 | 10.0 |
| toner | | | | | | | | toner | | | | | | | |
| K4 | | | | | | | | M4 | | | | | | | |
| Black | KA3 | 68.4 | 50 | C1 | 29.6 | S1 | 20.0 | M | MA3 | 76.4 | 50 | C1 | 31.6 | S1 | 10.0 |
| toner | | | | | | | | toner | | | | | | | |
| K5 | | | | | | | | M5 | | | | | | | |
| Black | KA4 | 68.4 | 50 | C1 | 29.6 | S1 | 20.0 | M | MA4 | 76.4 | 50 | C1 | 31.6 | S1 | 10.0 |
| toner | | | | | | | | toner | | | | | | | |
| K6 | | | | | | | | M6 | | | | | | | |
| Black | KA5 | 68.4 | 50 | C1 | 29.6 | S1 | 20.0 | M | MA5 | 76.4 | 50 | C1 | 31.6 | S1 | 10.0 |
| toner | | | | | | | | toner | | | | | | | |
| K7 | | | | | | | | M7 | | | | | | | |
| Black | KA6 | 68.4 | 50 | C1 | 29.6 | S1 | 20.0 | M | MA6 | 76.4 | 50 | C1 | 31.6 | S1 | 10.0 |
| toner | | | | | | | | toner | | | | | | | |
| K8 | | | | | | | | M8 | | | | | | | |
| Black | KA1 | 78 | 50 | C1 | 32 | S1 | 8.0 | M | MA7 | 76.4 | 50 | C1 | 31.6 | S1 | 10.0 |
| toner | | | | | | | | toner | | | | | | | |
| K9 | | | | | | | | M9 | | | | | | | |
| Black | KA1 | 66.8 | 50 | C1 | 29.2 | S1 | 22.0 | M | MA8 | 76.4 | 50 | C1 | 31.6 | S1 | 10.0 |
| toner | | | | | | | | toner | | | | | | | |
| K10 | | | | | | | | M10 | | | | | | | |
| Black | KA1 | 65.2 | 50 | C1 | 28.8 | S1 | 24.0 | M | MA9 | 76.4 | 50 | C1 | 31.6 | S1 | 10.0 |
| toner | | | | | | | | toner | | | | | | | |
| K11 | | | | | | | | M11 | | | | | | | |
| Black | KA1 | 68.4 | 50 | C1 | 29.6 | S2 | 20.0 | M | MA10 | 76.4 | 50 | C1 | 31.6 | S1 | 10.0 |
| toner | | | | | | | | toner | | | | | | | |
| K12 | | | | | | | | M12 | | | | | | | |
| Black | KA1 | 68.4 | 50 | C1 | 29.6 | S3 | 20.0 | M | MA1 | 71.6 | 50 | C1 | 36.4 | S1 | 10.0 |
| toner | | | | | | | | toner | | | | | | | |
| K13 | | | | | | | | M13 | | | | | | | |
| Black | KA1 | 68.4 | 50 | C1 | 29.6 | S4 | 20.0 | M | MA1 | 79.2 | 50 | C1 | 28.8 | S1 | 10.0 |
| toner | | | | | | | | toner | | | | | | | |
| K14 | | | | | | | | M14 | | | | | | | |
| Black | KA1 | 68.4 | 50 | C1 | 29.6 | S5 | 20.0 | M | MA1 | 72.9 | 50 | C1 | 35.1 | S1 | 10.0 |
| toner | | | | | | | | toner | | | | | | | |
| K15 | | | | | | | | M15 | | | | | | | |
| Black | KA1 | 68.4 | 50 | C1 | 29.6 | S6 | 20.0 | M | MA1 | 79.5 | 50 | C1 | 28.5 | S1 | 10.0 |
| toner | | | | | | | | toner | | | | | | | |
| K16 | | | | | | | | M16 | | | | | | | |
| Black | KA1 | 68.4 | 50 | C2 | 29.6 | S1 | 20.0 | M | MA1 | 70 | 50 | C1 | 30.0 | S1 | 18.0 |
| toner | | | | | | | | toner | | | | | | | |
| K17 | | | | | | | | M17 | | | | | | | |
| Black | KA1 | 68.4 | 50 | C3 | 29.6 | S1 | 20.0 | M | MA1 | 82.8 | 50 | C1 | 33.2 | S1 | 2.0 |
| toner | | | | | | | | toner | | | | | | | |
| K18 | | | | | | | | M18 | | | | | | | |
| Black | KA1 | 68.4 | 50 | C4 | 29.6 | S1 | 20.0 | M | MA1 | 71.6 | 50 | C1 | 30.4 | S1 | 16.0 |
| toner | | | | | | | | toner | | | | | | | |
| K19 | | | | | | | | M19 | | | | | | | |
| Black | KA1 | 68.4 | 50 | C5 | 29.6 | S1 | 20.0 | M | MA1 | 76.4 | 50 | C1 | 31.6 | S2 | 10.0 |
| toner | | | | | | | | toner | | | | | | | |
| K20 | | | | | | | | M20 | | | | | | | |
| Black | KA1 | 89.1 | 50 | C1 | 8.9 | S1 | 20.0 | M | MA1 | 76.4 | 50 | C1 | 31.6 | S3 | 10.0 |
| toner | | | | | | | | toner | | | | | | | |
| K21 | | | | | | | | M21 | | | | | | | |
| Black | KA1 | 37.3 | 50 | C1 | 60.7 | S1 | 20.0 | M | MA1 | 76.4 | 50 | C1 | 31.6 | S4 | 10.0 |
| toner | | | | | | | | toner | | | | | | | |
| K22 | | | | | | | | M22 | | | | | | | |
| | | | | | | | | M | MA1 | 76.4 | 50 | C1 | 31.6 | S5 | 10.0 |
| | | | | | | | | toner | | | | | | | |
| | | | | | | | | M23 | | | | | | | |
| | | | | | | | | M | MA1 | 76.4 | 50 | C1 | 31.6 | S6 | 10.0 |
| | | | | | | | | toner | | | | | | | |
| | | | | | | | | M24 | | | | | | | |
| | | | | | | | | M | MA1 | 76.4 | 50 | C1 | 31.6 | S1 | 10.0 |
| | | | | | | | | toner | | | | | | | |
| | | | | | | | | M25 | | | | | | | |
| | | | | | | | | M | MA1 | 76.4 | 50 | C1 | 31.6 | S1 | 10.0 |
| | | | | | | | | toner | | | | | | | |
| | | | | | | | | M26 | | | | | | | |
| | | | | | | | | M | MA1 | 76.4 | 50 | C1 | 31.6 | S1 | 10.0 |
| | | | | | | | | toner | | | | | | | |
| | | | | | | | | M27 | | | | | | | |
| | | | | | | | | M | MA1 | 76.4 | 50 | C1 | 31.6 | S1 | 10.0 |
| | | | | | | | | toner | | | | | | | |
| | | | | | | | | M28 | | | | | | | |
| | | | | | | | | M | MA1 | 98.5 | 50 | C1 | 9.5 | S1 | 10.0 |
| | | | | | | | | toner | | | | | | | |
| | | | | | | | | M29 | | | | | | | |
| | | | | | | | | M | MA1 | 43.2 | 50 | C1 | 64.8 | S1 | 10.0 |
| | | | | | | | | toner | | | | | | | |
| | | | | | | | | M30 | | | | | | | |
| | | | | | | | | M | MA11 | 76.4 | 50 | C1 | 31.6 | S1 | 10.0 |
| | | | | | | | | toner | | | | | | | |
| | | | | | | | | M31 | | | | | | | |
| | | | | | | | | M | MA12 | 76.4 | 50 | C1 | 31.6 | S1 | 10.0 |
| | | | | | | | | toner | | | | | | | |
| | | | | | | | | M32 | | | | | | | |

TABLE 5-1

| | | | Toner characteristics | | | | | | | |
|---|---|---|---|---|---|---|---|---|---|---|
| | | | Mass proportion of constitutional unit | | | Mass proportion of | | | | |
| | | | derived from phthalic acid other | | | constitutional unit derived | | Content of | | |
| | | | than terephthalic acid | | | from terephthalic acid | | crystalline PES resin | | |
| | Toner | | Black | Magenta | | Black | Magenta | Black | Magenta | |
| | Black | Magenta | toner | toner | P(M) − | toner | toner | toner | toner | |
| | toner | toner | P(K) | P(M) | P(K) | PT(K) | PT(M) | WC(K) | WC(M) | WC(K)/ |
| | Toner | Toner | (% by | (% by | (% by | (% by | (% by | (% by | (% by | WC(M) |
| | type | type | mass) | mass) | mass) | mass) | mass) | mass) | mass) | — |
| Example 1 | K1 | M1 | 5 | 30 | 25 | 80 | 55 | 20 | 20 | 1 |
| Example 2 | K2 | M1 | 5 | 30 | 25 | 80 | 55 | 40 | 20 | 2.00 |
| Example 3 | K3 | M1 | 5 | 30 | 25 | 80 | 55 | 7 | 20 | 0.35 |
| Example 4 | K1 | M2 | 5 | 30 | 25 | 80 | 55 | 20 | 40 | 0.50 |
| Example 5 | K1 | M3 | 5 | 30 | 25 | 80 | 55 | 20 | 7 | 2.86 |
| Example 6 | K4 | M4 | 0 | 40 | 40 | 85 | 45 | 20 | 20 | 1 |
| Example 7 | K1 | M4 | 5 | 40 | 35 | 80 | 45 | 20 | 20 | 1 |
| Example 8 | K1 | M5 | 5 | 20 | 15 | 80 | 65 | 20 | 20 | 1 |
| Example 9 | K5 | M5 | 10 | 20 | 10 | 75 | 65 | 20 | 20 | 1 |
| Example 10 | K4 | M6 | 0 | 10 | 10 | 85 | 75 | 20 | 20 | 1 |
| Example 11 | K4 | M7 | 0 | 11 | 11 | 85 | 74 | 20 | 20 | 1 |
| Example 12 | K4 | M8 | 0 | 15 | 15 | 85 | 70 | 20 | 20 | 1 |
| Example 13 | K6 | M9 | 20 | 50 | 30 | 65 | 35 | 20 | 20 | 1 |
| Example 14 | K7 | M10 | 46.5 | 80 | 33.5 | 53.5 | 5 | 20 | 20 | 1 |
| Example 15 | K7 | M11 | 46.5 | 81 | 34.5 | 53.5 | 4 | 20 | 20 | 1 |
| Example 16 | K8 | M12 | 33 | 70 | 37 | 32 | 15 | 20 | 20 | 1 |
| Example 17 | K1 | M13 | 5 | 30 | 25 | 80 | 55 | 20 | 23 | 0.87 |
| Example 18 | K1 | M14 | 5 | 30 | 25 | 80 | 55 | 20 | 18.2 | 1.10 |
| Example 19 | K1 | M15 | 5 | 30 | 25 | 80 | 55 | 20 | 22.2 | 0.90 |
| Example 20 | K1 | M16 | 5 | 30 | 25 | 80 | 55 | 20 | 18 | 1.11 |
| Example 21 | K9 | M17 | 5 | 30 | 25 | 80 | 55 | 20 | 20 | 1 |
| Example 22 | K1 | M17 | 5 | 30 | 25 | 80 | 55 | 20 | 20 | 1 |
| Example 23 | K10 | M18 | 5 | 30 | 25 | 80 | 55 | 20 | 20 | 1 |
| Example 24 | K1 | M19 | 5 | 30 | 25 | 80 | 55 | 20 | 20 | 1 |
| Example 25 | K11 | M18 | 5 | 30 | 25 | 80 | 55 | 20 | 20 | 1 |
| Example 26 | K12 | M1 | 5 | 30 | 25 | 80 | 55 | 20 | 20 | 1 |
| Example 27 | K13 | M1 | 5 | 30 | 25 | 80 | 55 | 20 | 20 | 1 |
| Example 28 | K14 | M1 | 5 | 30 | 25 | 80 | 55 | 20 | 20 | 1 |
| Example 29 | K15 | M1 | 5 | 30 | 25 | 80 | 55 | 20 | 20 | 1 |
| Example 30 | K1 | M20 | 5 | 30 | 25 | 80 | 55 | 20 | 20 | 1 |
| Example 31 | K1 | M21 | 5 | 30 | 25 | 80 | 55 | 20 | 20 | 1 |
| Example 32 | K1 | M22 | 5 | 30 | 25 | 80 | 55 | 20 | 20 | 1 |
| Example 33 | K1 | M23 | 5 | 30 | 25 | 80 | 55 | 20 | 20 | 1 |
| Example 34 | K16 | M1 | 5 | 30 | 25 | 80 | 55 | 20 | 20 | 1 |
| Example 35 | K1 | M24 | 5 | 30 | 25 | 80 | 55 | 20 | 20 | 1 |
| Example 36 | K17 | M1 | 5 | 30 | 25 | 80 | 55 | 20 | 20 | 1 |
| Example 37 | K18 | M1 | 5 | 30 | 25 | 80 | 55 | 20 | 20 | 1 |
| Example 38 | K19 | M1 | 5 | 30 | 25 | 80 | 55 | 20 | 20 | 1 |
| Example 39 | K20 | M1 | 5 | 30 | 25 | 80 | 55 | 20 | 20 | 1 |
| Example 40 | K1 | M25 | 5 | 30 | 25 | 80 | 55 | 20 | 20 | 1 |
| Example 41 | K1 | M26 | 5 | 30 | 25 | 80 | 55 | 20 | 20 | 1 |
| Example 42 | K1 | M27 | 5 | 30 | 25 | 80 | 55 | 20 | 20 | 1 |
| Example 44 | K1 | M28 | 5 | 30 | 25 | 80 | 55 | 20 | 20 | 1 |
| Comparative | K21 | M1 | 5 | 30 | 25 | 80 | 55 | 6 | 20 | 0.30 |
| Example 1 | | | | | | | | | | |
| Comparative | K22 | M1 | 5 | 30 | 25 | 80 | 55 | 41 | 20 | 2.05 |
| Example 2 | | | | | | | | | | |
| Comparative | K1 | M29 | 5 | 30 | 25 | 80 | 55 | 20 | 6 | 3.33 |
| Example 3 | | | | | | | | | | |
| Comparative | K1 | M30 | 5 | 30 | 25 | 80 | 55 | 20 | 41 | 0.49 |
| Example 4 | | | | | | | | | | |
| Comparative | K1 | M31 | 5 | 14 | 9 | 80 | 71 | 20 | 20 | 1 |
| Example 5 | | | | | | | | | | |
| Comparative | K1 | M32 | 5 | 46 | 41 | 80 | 39 | 20 | 20 | 1 |
| Example 6 | | | | | | | | | | |

TABLE 5-2

| | Toner characteristics | | | | | | |
|---|---|---|---|---|---|---|---|
| | THF-insoluble component | | | | | | |
| | Black toner | | | Magenta toner | | | |
| | | | Amount | | | Amount | WT(K) − |
| | Component | Tg | WT(K) | Component | Tg | WT(M) | WT(M) |
| | type | (° C.) | (% by mass) | type | (° C.) | (% by mass) | (% by mass) |
| Example 1 | StAc | 14.5 | 26 | StAc | 14.5 | 21 | 5 |
| Example 2 | StAc | 14.5 | 26 | StAc | 14.5 | 21 | 5 |
| Example 3 | StAc | 14.5 | 26 | StAc | 14.5 | 21 | 5 |
| Example 4 | StAc | 14.5 | 26 | StAc | 14.5 | 21 | 5 |
| Example 5 | StAc | 14.5 | 26 | StAc | 14.5 | 21 | 5 |
| Example 6 | StAc | 14.5 | 26 | StAc | 14.5 | 21 | 5 |
| Example 7 | StAc | 14.5 | 26 | StAc | 14.5 | 21 | 5 |
| Example 8 | StAc | 14.5 | 26 | StAc | 14.5 | 21 | 5 |
| Example 9 | StAc | 14.5 | 26 | StAc | 14.5 | 21 | 5 |
| Example 10 | StAc | 14.5 | 26 | StAc | 14.5 | 21 | 5 |
| Example 11 | StAc | 14.5 | 26 | StAc | 14.5 | 21 | 5 |
| Example 12 | StAc | 14.5 | 26 | StAc | 14.5 | 21 | 5 |
| Example 13 | StAc | 14.5 | 26 | StAc | 14.5 | 21 | 5 |
| Example 14 | StAc | 14.5 | 26 | StAc | 14.5 | 21 | 5 |
| Example 15 | StAc | 14.5 | 26 | StAc | 14.5 | 21 | 5 |
| Example 16 | StAc | 14.5 | 26 | StAc | 14.5 | 21 | 5 |
| Example 17 | StAc | 14.5 | 26 | StAc | 14.5 | 21 | 5 |
| Example 18 | StAc | 14.5 | 26 | StAc | 14.5 | 21 | 5 |
| Example 19 | StAc | 14.5 | 26 | StAc | 14.5 | 21 | 5 |
| Example 20 | StAc | 14.5 | 26 | StAc | 14.5 | 21 | 5 |
| Example 21 | StAc | 14.5 | 20 | StAc | 14.5 | 25 | −5 |
| Example 22 | StAc | 14.5 | 26 | StAc | 14.5 | 25 | 1 |
| Example 23 | StAc | 14.5 | 27 | StAc | 14.5 | 17 | 10 |
| Example 24 | StAc | 14.5 | 26 | StAc | 14.5 | 24 | 2 |
| Example 25 | StAc | 14.5 | 28 | StAc | 14.5 | 17 | 11 |
| Example 26 | StAc | −1 | 26 | StAc | 14.5 | 21 | 5 |
| Example 27 | StAc | 29.6 | 26 | StAc | 14.5 | 21 | 5 |
| Example 28 | StAc | 0.1 | 26 | StAc | 14.5 | 21 | 5 |
| Example 29 | StAc | 31.2 | 26 | StAc | 14.5 | 21 | 5 |
| Example 30 | StAc | 14.5 | 26 | StAc | −1 | 21 | 5 |
| Example 31 | StAc | 14.5 | 26 | StAc | 29.6 | 21 | 5 |
| Example 32 | StAc | 14.5 | 26 | StAc | 0.1 | 21 | 5 |
| Example 33 | StAc | 14.5 | 26 | StAc | 31.2 | 21 | 5 |
| Example 34 | St-butadiene | 14.9 | 26 | StAc | 14.5 | 21 | 5 |
| Example 35 | StAc | 14.5 | 26 | St-butadiene | 14.9 | 21 | 5 |
| Example 36 | StAc | 14.5 | 26 | StAc | 14.5 | 21 | 5 |
| Example 37 | StAc | 14.5 | 26 | StAc | 14.5 | 21 | 5 |
| Example 38 | StAc | 14.5 | 26 | StAc | 14.5 | 21 | 5 |
| Example 39 | StAc | 14.5 | 26 | StAc | 14.5 | 21 | 5 |
| Example 40 | StAc | 14.5 | 26 | StAc | 14.5 | 21 | 5 |
| Example 41 | StAc | 14.5 | 26 | StAc | 14.5 | 21 | 5 |
| Example 42 | StAc | 14.5 | 26 | StAc | 14.5 | 21 | 5 |
| Example 44 | StAc | 14.5 | 26 | StAc | 14.5 | 21 | 5 |
| Comparative | StAc | 14.5 | 26 | StAc | 14.5 | 21 | 5 |
| Example 1 | | | | | | | |
| Comparative | StAc | 14.5 | 26 | StAc | 14.5 | 21 | 5 |
| Example 2 | | | | | | | |
| Comparative | StAc | 14.5 | 26 | StAc | 14.5 | 21 | 5 |
| Example 3 | | | | | | | |
| Comparative | StAc | 14.5 | 26 | StAc | 14.5 | 21 | 5 |
| Example 4 | | | | | | | |
| Comparative | StAc | 14.5 | 26 | StAc | 14.5 | 21 | 5 |
| Example 5 | | | | | | | |
| Comparative | StAc | 14.5 | 26 | StAc | 14.5 | 21 | 5 |
| Example 6 | | | | | | | |

TABLE 5-3

| | Toner characteristics | | Evaluation | | |
|---|---|---|---|---|---|
| | Maximal peak temperature | | Low-temperature | Non-uniformity of | |
| | of DSC curve | | fixability | glossiness in image | |
| | Black toner | Magenta toner | (cold offset | After standing under | After standing in |
| | ° C. | ° C. | of image) | direct sunlight | dark room |
| Example 1 | 63.0 | 63.1 | A | G0 | G0 |
| Example 2 | No peak | 63.1 | A | G3 | G3 |
| Example 3 | No peak | 63.1 | B | G2 | G2 |
| Example 4 | 63.0 | No peak | A | G2 | G3 |
| Example 5 | 63.0 | No peak | B | G3 | G2 |
| Example 6 | 63.5 | 63.2 | A | G3 | G0 |
| Example 7 | 63.0 | 63.2 | A | G1 | G0 |
| Example 8 | 63.0 | 63.9 | A | G2 | G0 |
| Example 9 | 62.8 | 63.9 | A | G3 | G0 |
| Example 10 | 63.5 | 63.3 | A | G3 | G0 |
| Example 11 | 63.5 | 63.8 | A | G2 | G0 |
| Example 12 | 63.5 | 63.7 | A | G2 | G0 |
| Example 13 | 62.9 | 62.6 | A | G1 | G0 |
| Example 14 | 62.8 | 62.8 | A | G2 | G1 |
| Example 15 | 62.8 | 63.3 | A | G3 | G1 |
| Example 16 | 63.1 | 63.8 | A | G3 | G2 |
| Example 17 | 63.0 | 60.1 | A | G3 | G3 |
| Example 18 | 63.0 | 64.1 | A | G2 | G2 |
| Example 19 | 63.0 | 61.2 | A | G1 | G3 |
| Example 20 | 63.0 | 64.9 | B | G3 | G2 |
| Example 21 | 62.5 | 63.9 | A | G3 | G0 |
| Example 22 | 63.0 | 63.9 | B | G3 | G0 |
| Example 23 | 63.3 | 62.2 | A | G1 | G0 |
| Example 24 | 63.0 | 63.5 | B | G1 | G0 |
| Example 25 | 63.1 | 62.2 | A | G2 | G0 |
| Example 26 | 60.9 | 63.1 | A | G3 | G0 |
| Example 27 | 63.9 | 63.1 | B | G2 | G0 |
| Example 28 | 62.2 | 63.1 | A | G1 | G0 |
| Example 29 | 64.0 | 63.1 | B | G3 | G1 |
| Example 30 | 63.0 | 60.8 | A | G3 | G0 |
| Example 31 | 63.0 | 62.0 | A | G1 | G0 |
| Example 32 | 63.0 | 62.4 | A | G2 | G0 |
| Example 33 | 63.0 | 64.2 | B | G2 | G1 |
| Example 34 | 63.8 | 63.1 | B | G3 | G1 |
| Example 35 | 63.0 | 63.7 | B | G3 | G1 |
| Example 36 | 49.1 | 63.1 | A | G3 | G3 |
| Example 37 | 69.8 | 63.1 | B | G1 | G3 |
| Example 38 | 50.1 | 63.1 | A | G2 | G3 |
| Example 39 | 71.0 | 63.1 | B | G3 | G3 |
| Example 40 | 63.0 | 49.6 | A | G3 | G3 |
| Example 41 | 63.0 | 69.9 | B | G2 | G3 |
| Example 42 | 63.0 | 50.6 | A | G1 | G3 |
| Example 44 | 63.0 | 71.7 | B | G3 | G3 |
| Comparative | No peak | 63.1 | C | G3 | G3 |
| Example 1 | | | | | |
| Comparative | No peak | 63.1 | A | G4 | G4 |
| Example 2 | | | | | |
| Comparative | 63.0 | No peak | C | G4 | G3 |
| Example 3 | | | | | |
| Comparative | 63.0 | No peak | A | G4 | G4 |
| Example 4 | | | | | |
| Comparative | 63.0 | 63.5 | A | G4 | G0 |
| Example 5 | | | | | |
| Comparative | 63.0 | 63.2 | A | G4 | G0 |
| Example 6 | | | | | |

From the above results, it is found that the toners of the present examples can suppress the non-uniformity of the glossiness between the black image and the magenta image generated in a case of being exposed to the outdoor environment while ensuring the low-temperature fixability, as compared with the toners of the comparative examples.

The present exemplary embodiment includes the following aspects.

(((1)))

An electrostatic charge image developing toner set comprising:
a black toner having black toner particles that contain a binder resin and a black colorant; and
a magenta toner having magenta toner particles that contain a binder resin and a magenta colorant,
wherein the binder resin contained in the black toner particles and the magenta toner particles includes an amorphous polyester resin and a crystalline polyester resin,
a content of the crystalline polyester resin with respect to the binder resin in the black toner particles and the magenta toner particles is 7% by mass or more and 40% by mass or less,
the amorphous polyester resin contained in the black toner particles and the magenta toner particles consists of a constitutional unit derived from a polyvalent carboxylic acid and a constitutional unit derived from a polyhydric alcohol, and
a relationship between a mass proportion (% by mass) P(K) of the constitutional unit derived from a phthalic acid other than terephthalic acid with respect to the constitutional unit derived from a polyvalent carboxylic acid in the amorphous polyester resin contained in the black toner particles and a mass proportion (% by mass) P(M) of the constitutional unit derived from a phthalic acid other than terephthalic acid with respect to the constitutional unit derived from a polyvalent carboxylic acid in the amorphous polyester resin contained in the magenta toner particles satisfies the following expression (P1),

$$\begin{matrix}expression ( P1 ) & \\ 10 \leq P ( M ) - P ( K ) \leq 40. & ( ( ( 2 ) ) )\end{matrix}$$

The electrostatic charge image developing toner set according to (((1))),
wherein the relationship between the mass proportion (% by mass) P(K) of the constitutional unit derived from a phthalic acid other than terephthalic acid in the black toner particles and the mass proportion (% by mass) P(M) of the constitutional unit derived from a phthalic acid other than terephthalic acid in the magenta toner particles satisfies the following expression (P2),

$$\begin{matrix}expression ( P2 ) & \\ 15 \leq P ( M ) - P ( K ) \leq 35. & ( ( ( 3 ) ) )\end{matrix}$$

The electrostatic charge image developing toner set according to (((1))) or (((2))), wherein the mass proportion (% by mass) P(M) of the constitutional unit derived from a phthalic acid other than terephthalic acid is 11% by mass or more and 80% by mass or less.

(((4)))

The electrostatic charge image developing toner set according to (((3))), wherein the mass proportion (% by mass) P(M) of the constitutional unit derived from a phthalic acid other than terephthalic acid is 15% by mass or more and 50% by mass or less.

(((5)))

The electrostatic charge image developing toner set according to any one of (((1))) to (((4))),
wherein the constitutional unit derived from a polyvalent carboxylic acid in the amorphous polyester resin contained in the black toner particles includes a constitutional unit derived from terephthalic acid as a principle component.

(((6)))

The electrostatic charge image developing toner set according to any one of (((1))) to (((5))),
wherein a relationship between a content (% by mass) WC(K) of the crystalline polyester resin with respect to the binder resin in the black toner particles and a content (% by mass) WC(M) of the crystalline polyester resin with respect to the binder resin in the magenta toner particles satisfies the following expression (WC1),

$$\begin{matrix}expression ( WC1 ) & \\ 0.90 \leq WC ( K ) / WC ( M ) \leq 1 \text{.10} . & ( ( ( 7 ) ) )\end{matrix}$$

The electrostatic charge image developing toner set according to any one of (((1))) to (((6))),
wherein a tetrahydrofuran-insoluble amount (% by mass) WT(K) of the black toner particles and a tetrahydrofuran-insoluble amount (% by mass) WT(M) of the magenta toner particles are each 10% by mass or more and 40% by mass or less, and a relationship between the tetrahydrofuran-insoluble amounts WT(K) and WT(M) satisfies the following expression (WT1),

$$\begin{matrix}expression ( WT1 ) & \\ WT ( K ) > WT ( M ) . & ( ( ( 8 ) ) )\end{matrix}$$

The electrostatic charge image developing toner set according to (((7))),
wherein the relationship between the tetrahydrofuran-insoluble amount (% by mass) WT(K) of the black toner particles and the tetrahydrofuran-insoluble amount (% by mass) WT(M) of the magenta toner particles satisfies the following expression (WT2),

$$\begin{matrix}expression ( WT2 ) & \\ 2 \leq WT ( K ) - WT ( M ) \leq 10. & ( ( ( 9 ) ) )\end{matrix}$$

The electrostatic charge image developing toner set according to (((7))) or (((8))),
wherein a tetrahydrofuran-insoluble component of the black toner particles and the magenta toner particles includes a resin having a glass transition temperature Tg of 0° C. or higher and 30° C. or lower.

(((10)))

The electrostatic charge image developing toner set according to (((9))),
wherein the resin having a glass transition temperature Tg of 0° C. or higher and 30° C. or lower is a styrene-(meth)acrylic copolymer.

(((11)))

The electrostatic charge image developing toner set according to any one of (((1))) to (((10))),
wherein the black toner and the magenta toner have a peak that is maximal in a range of 50° C. or higher and 70° C. or lower at a second temperature rise in a thermal analysis measurement by differential scanning calorimetry (DSC).

(((12)))

An electrostatic charge image developer set comprising:
a first electrostatic charge image developer that contains the black toner in the electrostatic charge image developing toner set according to any one of (((1))) to (((11))); and
a second electrostatic charge image developer that contains the magenta toner in the electrostatic charge image developing toner set according to any one of (((1))) to (((11))).

(((13)))

A toner cartridge set comprising:
a first toner cartridge that includes a container containing the black toner in the electrostatic charge image developing toner set according to any one of (((1))) to (((11))); and
a second toner cartridge that includes a container containing the magenta toner in the electrostatic charge image developing toner set according to any one of (((1))) to (((11))), wherein the toner cartridge set is attachable to and detachable from an image forming apparatus.

(((14)))

A process cartridge comprising:
a first developing device containing the first electrostatic charge image developer in the electrostatic charge image developer set according to (((12))); and
a second developing device containing the second electrostatic charge image developer in the electrostatic charge image developer set according to (((12))),
wherein the process cartridge is attachable to and detachable from an image forming apparatus.

(((15)))

An image forming apparatus comprising:
a first image forming unit that forms a black image using the black toner in the electrostatic charge image developing toner set according to any one of (((1))) to (((11)));
a second image forming unit that forms a magenta image using the magenta toner in the electrostatic charge image developing toner set according to any one of (((1))) to (((11)));
a transfer device that transfers the black image and the magenta image onto a recording medium; and
a fixing device that fixes the black image and the magenta image on the recording medium.

(((16)))

An image forming method comprising:
a first image forming step of forming a black image using the black toner in the electrostatic charge image developing toner set according to any one of (((1))) to (((11)));
a second image forming step of forming a magenta image using the magenta toner in the electrostatic charge image developing toner set according to any one of (((1))) to (((11)));
a transfer step of transferring the black image and the magenta image onto a recording medium; and
a fixing step of fixing the black image and the magenta image on the recording medium.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An electrostatic charge image developing toner set comprising:
a black toner having black toner particles that contain a binder resin and a black colorant; and
a magenta toner having magenta toner particles that contain a binder resin and a magenta colorant,
wherein the binder resin contained in the black toner particles and the magenta toner particles includes an amorphous polyester resin and a crystalline polyester resin,
a content of the crystalline polyester resin with respect to the binder resin in the black toner particles and the magenta toner particles is 7% by mass or more and 40% by mass or less,
the amorphous polyester resin contained in the black toner particles and the magenta toner particles consists of a constitutional unit derived from a polyvalent carboxylic acid and a constitutional unit derived from a polyhydric alcohol, and
a relationship between a mass proportion (% by mass) P(K) of the constitutional unit derived from a phthalic acid other than terephthalic acid with respect to the constitutional unit derived from a polyvalent carboxylic acid in the amorphous polyester resin contained in the black toner particles and a mass proportion (% by mass) P(M) of the constitutional unit derived from a phthalic acid other than terephthalic acid with respect to the constitutional unit derived from a polyvalent carboxylic acid in the amorphous polyester resin contained in the magenta toner particles satisfies the following expression (P1),
$$10 \leq P ( M ) - P ( K ) \leq 40 . \qquad expression ( P1 )$$

2. The electrostatic charge image developing toner set according to claim 1,
wherein the relationship between the mass proportion (% by mass) P(K) of the constitutional unit derived from a phthalic acid other than terephthalic acid in the black toner particles and the mass proportion (% by mass) P(M) of the constitutional unit derived from a phthalic acid other than terephthalic acid in the magenta toner particles satisfies the following expression (P2),
$$15 \leq P ( M ) - P ( K ) \leq 35 . \qquad expression ( P2 )$$

3. The electrostatic charge image developing toner set according to claim 1,
wherein the mass proportion (% by mass) P(M) of the constitutional unit derived from a phthalic acid other than terephthalic acid is 11% by mass or more and 80% by mass or less.

4. The electrostatic charge image developing toner set according to claim 3,
wherein the mass proportion (% by mass) P(M) of the constitutional unit derived from a phthalic acid other than terephthalic acid is 15% by mass or more and 50% by mass or less.

5. The electrostatic charge image developing toner set according to claim 1,
wherein the constitutional unit derived from a polyvalent carboxylic acid in the amorphous polyester resin contained in the black toner particles includes a constitutional unit derived from terephthalic acid as a principle component.

6. The electrostatic charge image developing toner set according to claim 1,
wherein a relationship between a content (% by mass) WC(K) of the crystalline polyester resin with respect to the binder resin in the black toner particles and a content (% by mass) WC(M) of the crystalline polyester resin with respect to the binder resin in the magenta toner particles satisfies the following expression (WC1),
$$0.90 \leq WC ( K ) / WC ( M ) \leq 1.10 . \qquad expression ( WC1 )$$

7. The electrostatic charge image developing toner set according to claim 1,
wherein a tetrahydrofuran-insoluble amount (% by mass) WT(K) of the black toner particles and a tetrahydrofuran-insoluble amount (% by mass) WT(M) of the magenta toner particles are each 10% by mass or more and 40% by mass or less, and a relationship between the tetrahydrofuran-insoluble amounts WT(K) and WT(M) satisfies the following expression (WT1),
$$WT ( K ) > WT ( M ) . \qquad expression ( WT1 )$$

8. The electrostatic charge image developing toner set according to claim 7,
wherein the relationship between the tetrahydrofuran-insoluble amount (% by mass) WT(K) of the black toner particles and the tetrahydrofuran-insoluble amount (% by mass) WT(M) of the magenta toner particles satisfies the following expression (WT2),
$$2 \leq WT ( K ) - WT ( M ) \leq 10 . \qquad expression ( WT2 )$$

9. The electrostatic charge image developing toner set according to claim 7,
wherein a tetrahydrofuran-insoluble component of the black toner particles and the magenta toner particles includes a resin having a glass transition temperature Tg of 0° C. or higher and 30° C. or lower.

10. The electrostatic charge image developing toner set according to claim 9,
wherein the resin having a glass transition temperature Tg of 0° C. or higher and 30° C. or lower is a styrene-(meth)acrylic copolymer.

11. The electrostatic charge image developing toner set according to claim 1,
wherein the black toner and the magenta toner have a peak that is maximal in a range of 50° C. or higher and 70° C. or lower at a second temperature rise in a thermal analysis measurement by differential scanning calorimetry (DSC).

12. An electrostatic charge image developer set comprising:
a first electrostatic charge image developer that contains the black toner in the electrostatic charge image developing toner set according to claim 1; and
a second electrostatic charge image developer that contains the magenta toner in the electrostatic charge image developing toner set according to claim 1.

13. An electrostatic charge image developer set comprising:
a first electrostatic charge image developer that contains the black toner in the electrostatic charge image developing toner set according to claim 2; and
a second electrostatic charge image developer that contains the magenta toner in the electrostatic charge image developing toner set according to claim 2.

14. An electrostatic charge image developer set comprising:
a first electrostatic charge image developer that contains the black toner in the electrostatic charge image developing toner set according to claim 3; and
a second electrostatic charge image developer that contains the magenta toner in the electrostatic charge image developing toner set according to claim 3.

15. An electrostatic charge image developer set comprising:
a first electrostatic charge image developer that contains the black toner in the electrostatic charge image developing toner set according to claim 4; and
a second electrostatic charge image developer that contains the magenta toner in the electrostatic charge image developing toner set according to claim 4.

16. An electrostatic charge image developer set comprising:
a first electrostatic charge image developer that contains the black toner in the electrostatic charge image developing toner set according to claim 5; and
a second electrostatic charge image developer that contains the magenta toner in the electrostatic charge image developing toner set according to claim 5.

17. A toner cartridge set comprising:
a first toner cartridge that includes a container containing the black toner in the electrostatic charge image developing toner set according to claim 1; and
a second toner cartridge that includes a container containing the magenta toner in the electrostatic charge image developing toner set according to claim 1,
wherein the toner cartridge set is attachable to and detachable from an image forming apparatus.

18. A process cartridge comprising:
a first developing device containing the first electrostatic charge image developer in the electrostatic charge image developer set according to claim 12; and
a second developing device containing the second electrostatic charge image developer in the electrostatic charge image developer set according to claim 12,
wherein the process cartridge is attachable to and detachable from an image forming apparatus.

19. An image forming apparatus comprising:
a first image forming unit that forms a black image using the black toner in the electrostatic charge image developing toner set according to claim 1;
a second image forming unit that forms a magenta image using the magenta toner in the electrostatic charge image developing toner set according to claim 1;
a transfer device that transfers the black image and the magenta image onto a recording medium; and
a fixing device that fixes the black image and the magenta image on the recording medium.

20. An image forming method comprising:
a first image forming step of forming a black image using the black toner in the electrostatic charge image developing toner set according to claim 1;
a second image forming step of forming a magenta image using the magenta toner in the electrostatic charge image developing toner set according to claim 1;
a transfer step of transferring the black image and the magenta image onto a recording medium; and
a fixing step of fixing the black image and the magenta image on the recording medium.
